(19) United States
(12) Patent Application Publication
(10) Pub. No.: US 2024/0309034 A1
(43) Pub. Date: Sep. 19, 2024

(54) Metal Phthalocyanine-Based Nanowire Devices and Methods of Preparation and Use Thereof

(71) Applicant: University of Puerto Rico, San Juan, PR (US)

(72) Inventors: Dalice Marie Piñero Cruz, San Juan, PR (US); Luis F. Fonseca, San Juan, PR (US); Jean C. Gonzalez-Espiet, San Juan, PR (US); Soraya Ysabel Flores-Chalco, San Juan, PR (US); Rubén E. Díaz-Rivera, San Juan, PR (US); Juan Antonio Cintron-Cruz, San Juan, PR (US)

(21) Appl. No.: 18/431,932

(22) Filed: Feb. 3, 2024

Related U.S. Application Data
(60) Provisional application No. 63/484,725, filed on Feb. 13, 2023.

(51) Int. Cl. C07F 15/06; G01N 27/416

(52) U.S. Cl. CPC C07F 15/065; G01N 27/416

(57) ABSTRACT

Metal phthalocyanine-based nanowire devices, and methods of preparation and use thereof are provided, in particular methods of gas sensing. In one aspect, provided herein are methods for monitoring a gaseous mixture for an analyte, comprising: providing a sensor comprising nanowires, wherein the nanowires comprise a metal phthalocyanine complex, contacting the sensor with the gaseous mixture; and monitoring the electrical properties of the sensor, wherein the presence of the analyte alters the electrical properties of the sensor.

### CROSS-REFERENCE TO RELATED APPLICATIONS

This application claims the benefit of priority of U.S. Provisional Application No. 63/484,725, filed Feb. 13, 2023, which is incorporated herein by reference in its entirety.

### STATEMENT REGARDING FEDERALLY SPONSORED RESEARCH

The claimed invention was made with U.S. Government support under grant number HRD1736093 awarded by the National Science Foundation (NSF). The government has certain rights in this invention.

### FIELD

The present disclosure relates to metal phthalocyanine-based nanowire devices, including electrodes comprising the same. The present disclosure also provides methods for preparation and use thereof, such as for detection of gases.

### BACKGROUND

Sensors for environmental monitoring require ultra-high sensitivity to detect pollutant gases at very low concentrations. Typical commercial equipment available for this purpose are bulky and with relatively high energy consumption demands, for example, FTIR and UV spectrometers, chemiluminescence analyzers, and similar apparatus.

Advancements in nanotechnology permit development of highly sensitive sensors with reduced size, low power consumption, and portability (see, Nazemi et al., 2019, Advanced Micro- and Nano-Gas Sensor Technology: A Review. Sensors. 19: 1285-1308). Current efforts fueled by ramping concerns of increasing levels of pollutants in the environment respond to an overexposure in urban areas to toxic gases such as carbon monoxide, ozone, particulate matter of sizes between 10 and 2.5 micrometers of diameter or smaller, volatile organic compounds (VOCs), ammonia, nitrogen oxides and other NOₓ species (Suter et al., Ammonia. EPA.gov https://www.epa.gov/caddis-vol2/ammonia #tab-2 (accessed Mar. 18, 2021)). Solid-state sensors for detecting oxidizing gases such as NOₓ, or reducing ones such as NH₃ are mainly based on metal oxide semiconductors (MOS) forming a conductance sensor. Conductance sensors include a selected material (chemiresistor) that changes its electrical resistance in response to reversible charge transfer reactions usually due to the chemisorption of oxidizing or reducing gases; most of them require high operation temperatures.

Ammonia is produced naturally from the action of microorganisms present in the soil, such as bacteria, that decompose organic matter (animal and plants waste, and trash). It also originates anthropogenically due to agricultural activity (nitrogen fertilizers), livestock activity (manure) and during certain factory production activities (Ammonia. ChemicalSafetyFacts.org https://www.chemicalsafetyfacts.org/ammonia/(accessed Jun. 1, 2021)). Detection and monitoring of NH₃ in the gaseous phase is very important since it can be very harmful to human health and promotes the formation of polluting inorganic fine particulate matter. Normal environmental NH₃ concentration is on the order of 5 ppb (Schiferl et al., 2016, Interannual Variability of Ammonia Concentrations over the United States: Sources and Implications. Atmospheric Chemistry and Physics 18: 12305-12328). Permissible exposure limits in the air according to the federal Occupational Safety and Health Administration (OSHA) is 50 ppm for 8 hours; the National Institute for Occupational Safety & Health (NIOSH) recommends an exposure limit of 25 ppm for 10 hours. Nonetheless, short time exposure to more than 300 ppm is highly dangerous to life and health (Ammonia. Hazardous Substance Fact Sheet https://nj.gov/health/eoh/rtkweb/documents/fs/0084.pdf (accessed Jun. 1, 2021)). MOS gas sensors for NH₃ detection at these low concentrations normally suffer from low selectivity and reduced accuracy (Liu et al., 2012, A survey on gas sensing technology. Sensors 12:9635-9665.).

Accordingly, there remains a need to develop new materials for gas sensing, as well as methods of making and using the same.

### SUMMARY

In one aspect, the present disclosure provides methods for monitoring a gaseous mixture for an analyte, comprising:
providing a sensor comprising nanowires, wherein the nanowires comprise a metal phthalocyanine complex of formula (I):

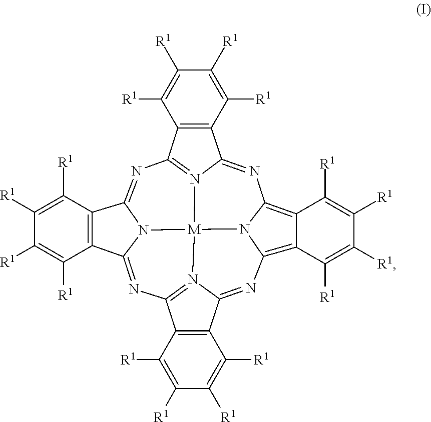

wherein M is iron or cobalt, and wherein each R¹ is independently H or F;
contacting the sensor with the gaseous mixture; and
monitoring the electrical properties of the sensor, wherein the presence of the analyte alters the electrical properties of the sensor.

In another aspect, the present disclosure provides methods for making a sensor, the sensor comprising nanowires on an gapped electrode, comprising:
providing a gapped electrode and a metal phthalocyanine complex of formula (I):

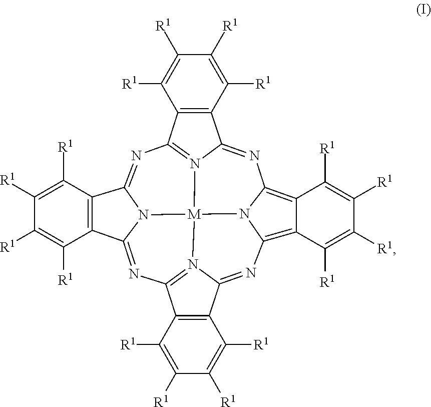

wherein M is iron or cobalt, and each R¹ is independently H or F;
reducing the pressure to no more than 1 Torr and raising the temperature to at least 100° C. for a time of at least 20 minutes,
wherein the metal phthalocyanine complex is deposited as nanowires on the gapped electrode.

A system for monitoring a gaseous mixture for an analyte, the system comprising:
a sensor comprising nanowires deposited on a gapped electrode, wherein the nanowires comprise a metal phthalocyanine complex, wherein the nanowires are deposited so as to complete an electrical circuit;
a meter connected to the electrical circuit and configured to measure the electrical properties of the sensor; and
an input stream configured to contact the gaseous mixture with the sensor, wherein the presence of the analyte alters the electrical properties of the sensor.

Other aspects of the disclosure will be apparent to those skilled in the art in view of the description that follows.

### BRIEF DESCRIPTION OF THE DRAWINGS

FIGS. 1A-1E illustrate electron microscopy analysis of as prepared F₁₆FePc nanowires. FIG. 1A shows low magnification SEM image showing uniform coverage of the electrodes, and FIG. 1B shows a TEM image of nanowire bundles on holey carbon grids. FIG. 1C shows an HRTEM image of a single nanowire. FIG. 1D shows electron diffraction pattern. FIG. 1E is a schematic overview of device characteristics and performance according to an example embodiment.

FIG. 2 illustrates normalized F₁₆FePc sensor's signal (Normalized S) as a function of time during exposure to 100 ppb of NH₃ in air and recovery in air. Continuous lines represent fittings using eq(1) and eq(2).

FIG. 3A illustrates normalized F₁₆FePc sensor response (Normalized S) as a function of time at different NH₃ concentrations for exposure times <3 hours, and FIG. 3B illustrates model fittings (continuous red lines) for F₁₆FePc sensor fast response as a function of time at different NH₃ concentrations.

FIG. 4A illustrates inverse of the time constant for the fast response process (1/τ_{1F}) as a function of the NH₃ concentrations, and FIG. 4B illustrates fast response saturation values (A_{1F}) as a function of the NH₃ concentrations.

FIG. 5A illustrates normalized response (Normalized S) of F₁₆FePc nanowires sensor to ON and OFF 100 ppb NH₃ gas cycles. Exposure time <30 min including three repetitions, and FIG. 5B illustrates normalized response (Normalized S) of F₁₆FePc nanowires sensor to 40 ppb NH₃ gas exposure at room temperature.

FIG. 6A illustrates comparison between the F₁₆FePc and FePc normalized sensors' response (Normalized S) to 100 ppb NH₃, and FIG. 6B illustrates normalized response (Normalized S) of the FePc sensor at 100 ppb NO₂.

FIGS. 7A-7B illustrate comparison between the F₁₆FePc and F₁₆CoPc sensors' response (Normalized S) to 100 ppb NH₃ for 75 hours as shown in FIG. 7A and 500 ppb NH₃ for 3 hrs as shown in FIG. 7B.

FIG. 8 illustrates a UV-Vis spectrum of the hexadecafluorophthalocyanine starting material, tetrafluorophthalonitrile (3,4,5,6-tetrafluoro-1,2-dicyanobenzene) in acetone.

FIG. 9 illustrates a UV-Vis spectrum of hexadecafluorinated iron phthalocyanine complex (F₁₆FePc) in acetone.

FIG. 10 illustrates a UV-Vis spectrum of hexadecafluorinated cobalt phthalocyanine complex F₁₆CoPc in acetone.

FIG. 11 illustrates a UV-Vis spectra of the starting material and the two hexadecafluorinated metal phthalocyanine complexes in acetone.

FIG. 12 illustrates an infrared spectrum of hexadecafluorinated iron phthalocyanine complex (F₁₆FePc).

FIG. 13 illustrates an infrared spectrum of hexadecafluorinated cobalt phthalocyanine complex (F₁₆CoPc).

FIG. 14 illustrates infrared spectra of the two hexadecafluorinated metal phthalocyanine complexes in acetone.

FIG. 15 illustrates a powder X-ray diffractogram of iron phthalocyanine powder before PVD.

FIG. 16 illustrates a powder X-ray diffractogram of cobalt phthalocyanine powder before PVD.

FIG. 17 illustrates a powder X-ray diffractogram of hexadecafluorinated iron phthalocyanine powder before PVD.

FIG. 18 illustrates a powder X-ray diffractogram of hexadecafluorinated cobalt phthalocyanine powder before PVD.

FIG. 19 illustrates a fabrication process flow of the IDEs with the bilayer lift-off method. In here we use a non-photoactive layer below the photoresist to develop an undercut during development and avoid metal deposition on vertical walls.

FIGS. 20A-20B illustrate SEM images of the electrodes area showing a high percentage of connecting NWs between adjacent electrodes. FIGS. 20C-20D illustrate nanowires with diameters <100 nm, belts and bundles are forming the chemiresistor network.

FIGS. 21A-21B illustrate SEM images of the electrodes area showing F₁₆CoPc. FIGS. 21C-21D illustrate SEM images of the electrodes area showing FePc.

FIG. 22 illustrates TEM images of F₁₆FePc nanowires. Left: a distribution of nanowires. Those with larger width are belts, thinner ones are nanowires. Right: A ˜120 nm single nanowire. Image shows a uniform and compact structure.

FIG. 23 illustrates TEM images of F₁₆FePc nanowires showing well-defined crystalline planes.

FIG. 24 illustrates an TEM image and a profile plot of 10 atomic planes selected for the calculation.

FIG. 25 illustrates an TEM image and a profile plot of 5 atomic planes selected for the calculation.

FIG. 26 illustrates an TEM image of where selected 8 measurements that have 5 atomic planes and table of this dataset.

FIG. 27 illustrates EDS analysis. EDS spectrum, TEM image and elemental mappings for F₁₆FePc nanowire.

FIGS. 28A-28B illustrate AFM mapping of F₁₆FePc nanowires. Left: a nanowire with ˜80 nm diameter. The image shows another wire bundled at the top. Right: A bundle of two wires. One is a belt with ˜70 nm thickness.

FIG. 29 illustrates experimental Raman spectra for F₁₆FePc, F₁₆CoPc and FePc.

FIG. 30 illustrates a powder X-ray diffractogram of iron phthalocyanine nanowires after PVD.

FIG. 31 illustrates a powder X-ray diffractogram of cobalt phthalocyanine nanowires after PVD.

FIG. 32 illustrates comparison of powder X-ray diffractograms of iron phthalocyanine powder and nanowires (before and after PVD).

FIG. 33 illustrates comparison of powder X-ray diffractograms of cobalt phthalocyanine powder and nanowires (before and after PVD).

FIG. 34 illustrates a powder X-ray diffractogram of hexadecafluorinated iron phthalocyanine nanowires after PVD.

FIG. 35 illustrates comparison of powder X-ray diffractograms of hexadecafluorinated iron phthalocyanine powder and nanowires (before and after PVD).

FIG. 36 illustrates a powder X-ray diffractogram of hexadecafluorinated cobalt phthalocyanine nanowires after PVD.

FIG. 37 illustrates comparison of powder X-ray diffractograms of hexadecafluorinated cobalt phthalocyanine powder and nanowires (before and after PVD).

FIG. 38 illustrates the as measured electrical current intensity as a function of time of a representative F₁₆FePc nanowires sensor prototype during 100 ppb NH₃ testing.

FIG. 39 illustrates F₁₆FePc nanowires normalized sensor response (Normalized S) to relatively high NH₃ concentrations in air in a period of ˜2 hours. At 25 ppm (NIOSH short term limit), S reaches 0.1 (10% current change) in just ˜45 seconds.

FIG. 40 illustrates a physical vapor deposition system used to synthesize the MPc nanowires.

### DETAILED DESCRIPTION

Herein, single-step production methods for gas sensing devices produced from unsubstituted and hexadecafluorinated metal phthalocyanines (MPc, M=Fe²⁺ or Co²⁺) is disclosed. Preparation of sensor devices by direct growth of nanowires on interdigitated electrodes by vapor transport of synthesized MPc precursors is set forth herein, emphasizing a single-step approach. Results using as-prepared devices for detecting NH₃ and NO₂ in the parts-per-billion (ppb) range are shown, demonstrating exceptional sensitivity compared to conventional sensors. In agreement with similar MPc sensing materials, response and recovery times fitted using a double exponential model gave two rate constants: a shorter one—in the order of minutes for concentrations above 500 ppb, and a longer one—in the order of hours. These rate constants are suitable for environmental monitoring of gases in recovery zones, where longer exposure times are critical in the sampling process. The F₁₆FePc-NWs sensor prototypes disclosed herein showed ˜10% normalized response towards NH₃ at 40 ppb for a measuring time of ˜2.5 hours at room temperature, and measurable responses to concentrations as low as 5 ppb, thus being applicable to environmental studies.

Among the various NH₃ and NO₂ proposed sensors from emerging technologies, those using organic semiconductors (OS) appear to be one of the most promising, especially when very low gas concentrations are involved. OS are one of the most versatile and studied organic materials (Bronstein et al., 2020, Nat. Rev. Chem. 4: 66-77); their high thermal and chemical stability facilitate their incorporation into a variety of organic electronic devices including organic thin film transistors (OTFTs), organic photovoltaics (OPVs; Kesters et al., 2015, Adv. Energy Mater 5:1-20), organic light emitting diodes (OLEDs; Hohnholz et al., 2000, J. Mol. Struct. 521: 231-237), and chemiresistors (Katz et al., 2004, Electroanalysis 16:1837-1842). One of the most popular and well-known OS materials proposed for gas sensing are based on metal phthalocyanines (MPcs, Scheme 1; see, Eley, 1948, Nature. 162: 819; Melville et al., 2-15, ACS Appl. Mater. Interfaces. 7: 13105-13118). MPc chemiresistors exhibit high sensitivity and chemical selectivity towards a variety of analytes (Katz et al., 2004). They are particularly attractive for gas sensing because their sensitivity and response towards various analytes can be tailored by: (i) the nature of the central metal atom, and (ii) the substituents in the aromatic rings, which can impart an n-type or p-type character to the OS according to their electron withdrawing/donating capability, and (iii) on the spatial organization of molecules in the lattice (see, Li et al., 2006, Inorg. Chem. 45: 2327-2334; Liao et al., 2005, J. Chem. Theory Comput. 1: 1201-1210).

Introduction of different central metals into the MPc ring can significantly alter the material's properties, and offers the possibility to change the complex's semiconducting behavior and sensor performance. Similarly, peripheral substitution of the conjugated macrocycle of MPcs by electron withdrawing or electron-donating groups is a straightforward way to vary sensitivity and selectivity of these materials toward different analytes. For example, fluorine substituents decrease the electron density of the aromatic ring, which in turn increases the oxidation potential of the MPc molecules (Liao et al., 2005). As a result, fluorosubstituted phthalocyanines exhibit a higher sensor response to reducing gases, such as NH₃ and H₂ (see, Klyamer et al., 2018, Sensors. 18: 1-13; Basova et al., 2016, Sensors Actuators, B Chem. 227: 634-642; Parkhomenko et al., 2017, J. Phys. Chem. C. 121: 1200-1209; Bao et al., 1998, J. Am. Chem. Soc., 7863: 207-208; Wannebroucq et al., 2017, RSC Advances 7: 41272-41281). High charge mobilities have also been measured in substituted MPc thin films as compared with unsubstituted ones, being F₁₆FePc the one with the larger mobility in some reported measurements (Bao et al., 1998; Wannebroucq et al., 2017). Unsubstituted or alkylated MPc are, on the contrary, more responsive towards oxidizing gases due to an increase in the electron density of the macrocycle that results in the lowering of the oxidation potential, thus facilitating the oxidation process. Since the first report by the Sadaoka group (Li et al., 2006), there have been numerous reports in the literature about Pc gas sensors: most of them involve the sensing of oxidizing and reducing gases, although sensing of VOCs with these systems has also been accomplished (see, Saini et al., 2014, RSC Adv. 4: 15945-15951; Wang et al., 2016, Micro Nano Lett. 11: 348-350.). These sensors, though often very sensitive to NO₂ and other oxidizing gases, appear to have problems in stability and/or response kinetics for practical use.

Set forth herein as methods for synthesizing metal phthalocyanine complexes and their hexadecafluorinated counterparts through a solid-state cyclotetramerization reaction.

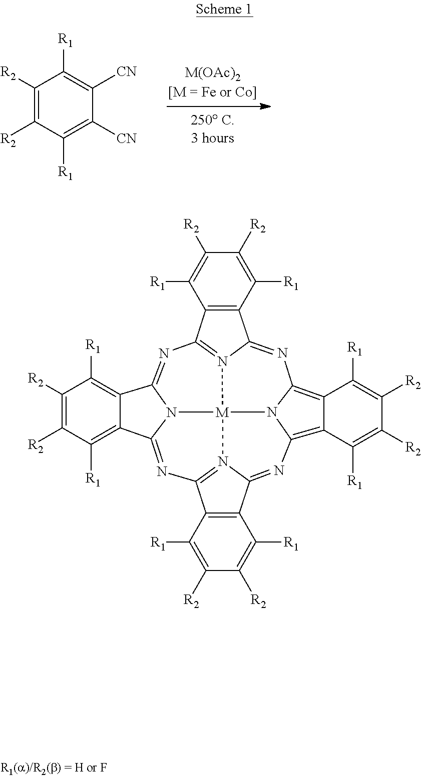

To improve sensor performance, incorporation of MPcs into nanomaterials enhances their chemiresistive properties. Several nanomaterials based on MPc complexes have been tested for the detection of pollutant gases. The work on conductance sensors by Basova et al. (2016) to develop thin films of PdPc demonstrated the chemiresistive behavior of these materials towards NH₃, with detection limits reaching 10 ppm (Parkhomenko et al., 2017). Other groups have further extended this discussion to include other nanomaterials towards a variety of gases like Cl₂, (Saini et al., 2014) EtOH, (Wang et al., 2016) H₂S, (Kumar et al., 2015, ACS Appl. Mater. Interfaces. 7:17713-17724) SO₂, (Shaymurat et al., 2013, Adv. Mater. 25: 2269-2273) NO₂ (Sun et al., 2018, New J. Chem. 42: 6713-6718.) among others (Duan et al., 2020, New J. Chem. 44: 13240-13248). Most of the proposed MPc gas sensors used thin films as the active component. With film thickness in the nanometer range, good sensitivities while maintaining relatively acceptable free charge mobilities have been disclosed. Substituted MPc such as FₓMPc films have also been studied showing enhanced sensitivity for detecting reducing gases. Physical vapor deposition (PVD) methods have been widely used for the deposition of active MPc thin films and spin coating of dissolved MPc material has also been demonstrated to be an alternative successful method compatible with large scale production. For the latter, the need of proper solvents becomes a point of consideration in such an approach. Besides the extensive research published based on thin film chemiresistors, a three-electrode sensor configuration forming MPc (unsubstituted and substituted) OTFT (organic thin-film transistors) have also been studied more recently with good results. Different from standard chemiresistors, their sensitivity can benefit from transistor signal amplification. Using Pc nanowires and other nanomaterials as the active material in organic field effect transistors (OFET) sensors has been documented in several reports but as far as we know none has been used for NH₃ detection (see, Bouvet et al., 2001, Sens. Actuators B Chem. 73: 63-70; Song et al., 2017, Org. Electron. 48: 68-76; Fleet et al., 2017, ACS Appl. Mater. Interfaces. 9: 20686-20695). For instance, Bouvet et al. (2001) detailed a Pc film-based OTFT sensor for ozone detection with sensitivity up to 10 ppb (Bouvet et al., 2001). Song et al. (2017) showed up to 20 ppb H₂S in N₂ response of an OFET based on a single CuPc modified nanowire (Song et al., 2017) while Fleet et al. (2017) reported high performance transistors with high electron mobility, low threshold voltage and low subthreshold swings (Fleet et al., 2017). Nanowires (NWs) are then promising nanostructures to work as chemiresistors when compared with films as they show larger surface to volume ratios and better uniformity, thus bringing larger charge carrier mobilities and stability (see, Tong et al., 2006, J. Phys. Chem. B. 110: 17406-17413; Ji et al., 2016, Cryst. Res. Technol. 51: 154-159). There are few recent reports of MPc NWs tested as chemiresistors with good results but none, thus far, about substituted FePc (Saini et al., 2014; Wang et al., 2016).

This disclosure relates to identification of promising MPc-based NWs that can be used to monitor concentration variations of contaminants in the atmosphere in areas identified as “Recovery Zones” and proposes practical approaches for developing and providing sensors based on MPc active materials. “Recovery Zones” are areas with previous history of contamination wherein air quality should be monitored as a function of time to assess improvements. For such applications, typical contaminants such as NH₃, NO₂ and VOCs, are expected to be above normal levels but still in the ppb range. At the same time, fast sensors' response and recovery times are not necessary because expected environmental changes take place in the range of weeks, minimum days. However, reduced operation power is desired as such devices work for long periods of time, including relatively isolated areas with no access to commercial electrical power. Reduced size permits development of multifunctional devices capable of monitoring several contaminants simultaneously to be developed.

Provided herein are procedures for fabricating highly sensitive conductometric sensors based on unsubstituted and hexadecafluorinated MPc (M=Fe²⁺ and Co²⁺) NWs through direct growth on interdigitated electrodes (IDEs) by PVD through a procedure similar to the one reported by Fleet et al (2017). In particular, sensors based on FePc and F₁₆FePc NWs were produced and compared with ones made from CoPc and F₁₆CoPc, because their response towards NO₂ and NH₃ has not been fully explored, while unsubstituted CoPc has shown good sensing capabilities towards both gases (see, Padma et al., 2009, Sens. Actuators B Chem. 143: 246-252; Wang et al., 2007, Org. Electron. 50: 389-396; Polyakov et al., 2017, Synth. Met. 227: 78-86; Malay et al., 2018, Chem. Phys. 513: 23-34). This method permits sensor prototypes to be prepared in a single step, producing stable and reproducible devices able to detect NO₂ and NH₃ gases in the low ppb range. To our knowledge, NWs from this fluorinated complex have not been obtained before and comparison of such chemiresistors response with other MPc-based materials for ammonia detection can clarify possible advantages of NWs for low concentration gas sensing as compared with thin films.

Accordingly, in one aspect, the present disclosure provides methods for monitoring a gaseous mixture for an analyte, comprising:
providing a sensor comprising nanowires, wherein the nanowires comprise a metal phthalocyanine complex of formula (I):

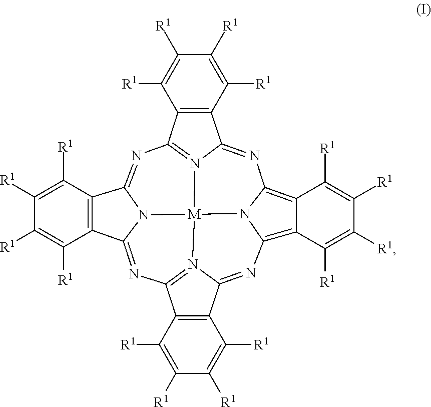

wherein M is iron or cobalt, and wherein each R¹ is independently H or F;
contacting the sensor with the gaseous mixture; and
monitoring the electrical properties of the sensor, wherein the presence of the analyte alters the electrical properties of the sensor.

In particular embodiments as otherwise described herein, M is iron, particularly Fe²⁺. In other embodiments, M is cobalt, particularly Co²⁺. In various embodiments, R¹ in each instance is H. In various other embodiments, R¹ in each instance is F.

As described herein, deposition of the metal phthalocyanine complex can form nanowires comprised of the complex. In certain embodiments as otherwise described herein, the nanowires are crystalline, for example, they exhibit x-ray diffraction. For instance, in some embodiments, the nanowires comprise a crystal polymorph characterized in that it provides an X-ray diffraction pattern comprising at least the peaks selected from one of the following sets (2θ±0.1 degrees):
(i) 7.1, 9.3; (ii) 7.1, 9.2; or (iii) 6.3, 28.5.

These nanowires are comprised of a majority of metal phthalocyanine complex. For example, in certain embodiments as otherwise described herein, the nanowires comprise at least 90 wt % metal phthalocyanine, for examples, at least 95 wt %, or at least 98 wt %, or at least 99 wt %, or at least 99.9 wt % metal phthalocyanine.

Advantageously, the chemical makeup of the nanowires can be altered, thus altering the electrical behavior of the nanowires. For example, in certain embodiments as otherwise described herein, the nanowires are semiconducting, e.g., are a p-type semiconductor or an n-type semiconductor. In particular embodiments, the nanowires are an n-type semiconductor.

In various embodiments, the nanowires are deposited on a gapped electrode. As known in the art, a gapped electrode is a conductive device wherein at least two elements are not in electrical contact with one another. As such, absent a material bridging the gap between elements, a circuit is not completed and no electrical current flows. Accordingly, in certain embodiments as otherwise described herein, the nanowires are deposited on the gapped electrode to complete an electrical circuit across the gapped electrode. In particular embodiments, the gapped electrode is an interdigitated electrode.

The gapped electrode may be formed by any process as known in the art and as disclosed herein. In certain embodiments, the gapped electrode is comprised of a conductive metal, for example, is comprised of copper, silver, aluminum, gold, zinc, iron, tin, platinum, palladium, or chromium. In particular embodiments, the gapped electrode comprises gold.

Advantageously, the sensor as described herein can detect the presence or absence of certain analyte gases in a gaseous mixture. Thus, in certain embodiments, for example where a signal is detected, the gaseous mixture comprises the analyte. Of course, in other embodiments, the gaseous mixture does not comprise the analyte. In various embodiments, the analyte comprises CO, NH₃, and/or NOₓ, wherein is 1 or 2. In particular embodiments, the analyte comprises NH₃ or NO, for example, NH₃. In some examples, the analyte is NH₃.

Unexpectedly, in various embodiments the analyte can be detected in very low concentrations, far below that conventionally achieved in the art. Further, in various embodiments the analyte can also be detected at relatively high concentrations, exhibiting excellent range without recalibration. Accordingly, in certain embodiments as otherwise described herein, the analyte is present in an amount in the range of 40 ppb to 10 wt %, for example, in the range of 40 ppb to 1 wt %, or 40 ppb to 100 ppm, or 40 ppb to 10 ppm, or 40 ppb to 1 ppm. In various embodiments, wherein the analyte is present in the foregoing ranges, a detectible signal is produced from the sensor.

The gaseous mixture can comprise components besides the analyte. For example, in various embodiments the gaseous mixture comprises at least one of N₂, O₂, or H₂O. For example, in some embodiments, the gaseous mixture comprises at least 80 wt % air, or at least 90 wt % air, or at least 95 wt % air, or at least 98 wt % air, or at least 99 wt % air. In some embodiments, the gaseous mixture can further be humid, wherein the humidity is in the range of 0% to 100% relative humidity.

In various embodiments, the presence of the analyte can result in a change in the electrical properties of the sensor. Accordingly, in certain embodiments as otherwise described here, the monitoring of the electrical properties comprises completing a circuit with the sensor, and monitoring at least one of the current, voltage, or resistance across the sensor.

In certain embodiments, wherein the gaseous mixture comprises an analyte, the method can further comprise:
determining a baseline current, voltage, or resistance across the sensor in the presence of a control gaseous mixture that does not comprise the analyte, and then
determining a detection current, voltage, or resistance across the sensor in the presence of the gaseous mixture.

In certain embodiments, the disclosed methods further comprise determining a calibration for the sensor properties as a function of analyte concentration, and using the calibration to detect an experimental quantity of the analyte.

In another aspect, the present disclosure provides methods for making a sensor as otherwise described herein, the sensor comprising nanowires on an gapped electrode, the method comprising:
providing a gapped electrode and a metal phthalocyanine complex of formula (I):

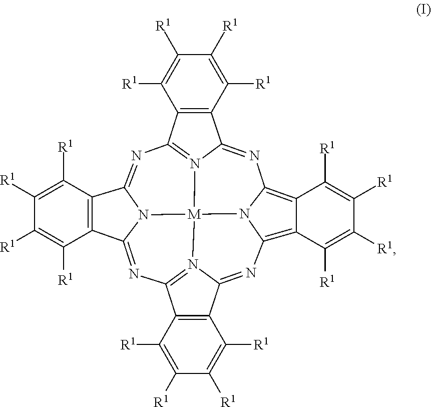

wherein M is iron or cobalt, and each R¹ is independently H or F;
reducing the pressure to no more than 1 Torr and raising the temperature to at least 100° C. for a time of at least 20 minutes,
wherein the metal phthalocyanine complex is deposited as nanowires on the gapped electrode.

In certain embodiments as otherwise described herein, the pressure is reduced to no more than 0.5 Torr, e.g., no more than 0.1 Torr, or 0.05 Torr. In some embodiments, after the pressure is reduced, a gas flow is started, wherein the gas flow is in the range of 10 to 1000 sccm (e.g., 50 to 500 sccm). In particular embodiments, the gas flow is sufficient to raise the pressure to at least 1.5 Torr, e.g., at least 2 Torr, or at least 3 Torr. For example, in various embodiments, the gas flow is sufficient to raise the pressure to no more than 20 Torr, e.g., no more than 15 Torr or no more than 10 Torr. In various embodiments, the gas flow is an inert gas, e.g., comprises N₂ and/or Ar, such as at least 99% N₂.

In certain embodiments as otherwise described herein, the temperature is raised to at least 200° C., or at least 300° C., or at least 350° C. For example, in various embodiments, the temperature is raised to no more than 500°, or no more than 450° C. In some embodiments, the temperature is raised in more than one stage. For example, in some embodiments, the temperature is raised to a first temperature in the range of 100° C. to 150° C., and then let dwell for a time in the range of 1 minute to 6 hours (e.g., for a time in the range of 10 minutes to 2 hours), and then raised to a second temperature in the range of 300° C. to 500° C. (e.g., 350° C. to 450° C.). The elevated temperature (e.g., the raised temperature if a single heating stage is used, or the second temperature if a multistage heating protocol is followed), is maintained for a time in the range of 10 minutes to 12 hours (e.g., in the range of 20 minutes to 6 hours, or in the range of 30 minutes to 3 hours).

In another aspect, the present disclosure provides sensors, the sensors comprising nanowires as otherwise described herein deposited on a gapped electrode as otherwise described herein, wherein the nanowires are comprised of a metal phthalocyanine complex of formula (I):

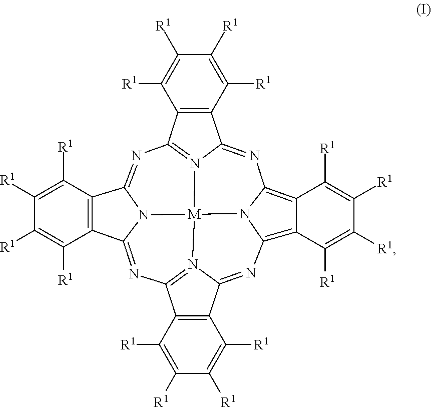

wherein M is iron or cobalt, and each R¹ is independently H or F.

In certain embodiments, the nanowires of the sensor are deposited using physical vapor deposition.

Also provided are systems for monitoring a gaseous mixture for an analyte as otherwise described herein, the system comprising:
a sensor comprising nanowires deposited on a gapped electrode, wherein the nanowires comprise a metal phthalocyanine complex, wherein the nanowires are deposited so as to complete an electrical circuit;
a meter connected to the electrical circuit and configured to measure the electrical properties of the sensor; and
an input stream configured to contact the gaseous mixture with the sensor, wherein the presence of the analyte alters the electrical properties of the sensor.

Techniques for monitoring the electrical properties of the sensor are known to a person of ordinary skill in the art, and may be adapted according to the present disclosure. Example electrical properties include the voltage, current, resistance or inductance.

### Examples

The Examples that follow are illustrative of specific embodiments of the disclosure, and various uses thereof. They are set forth for explanatory purposes only, and should not be construed as limiting the scope of the disclosure in any way.

### EXPERIMENTAL METHODS

### Synthesis of MPcs

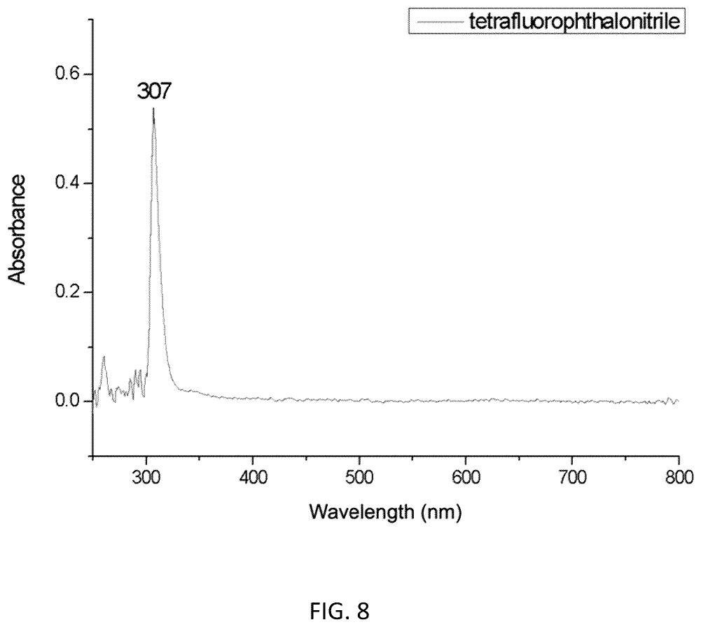

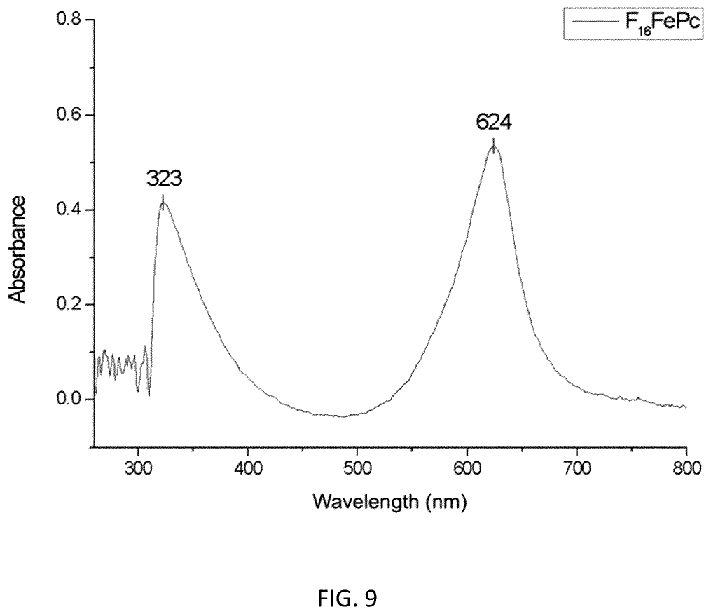

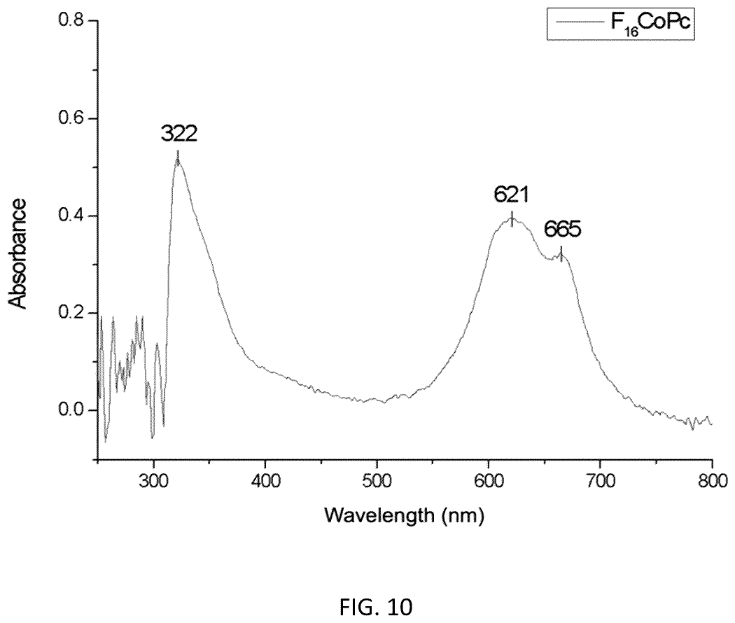

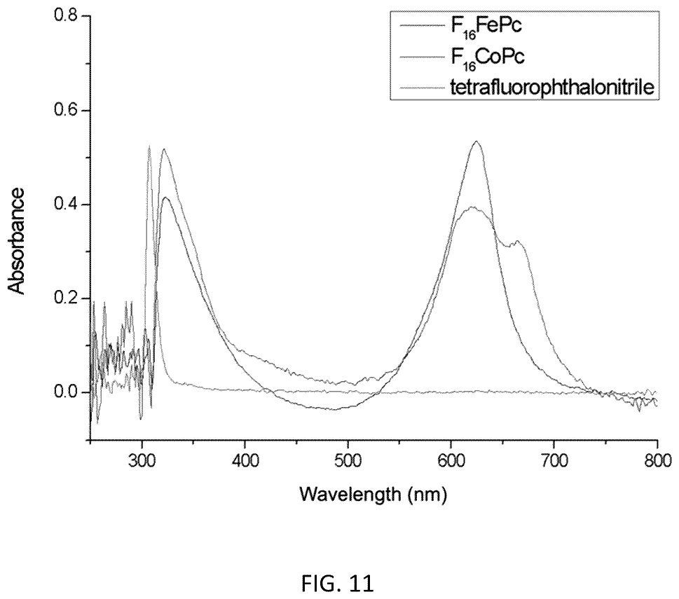

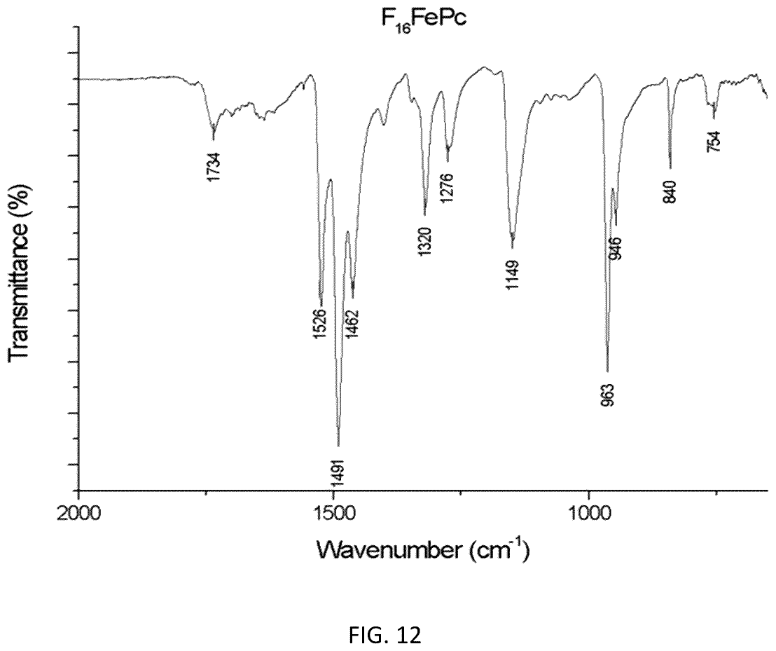

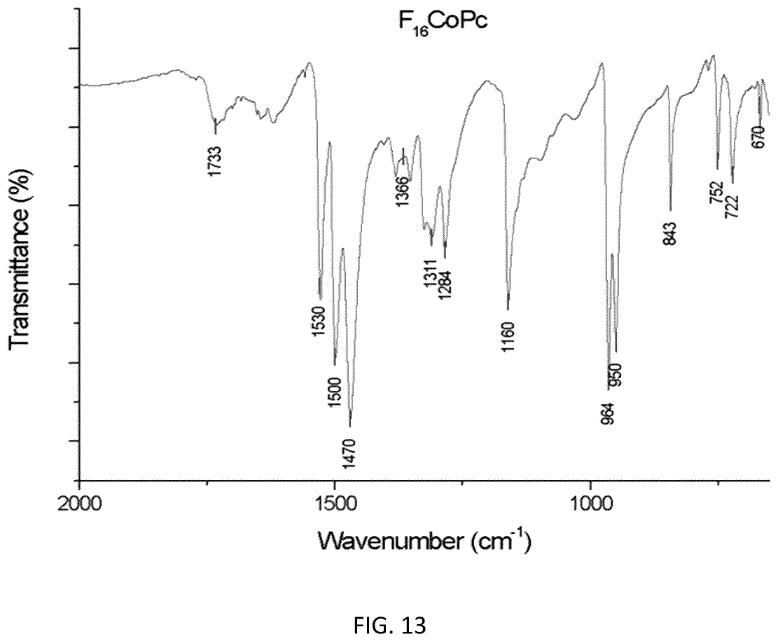

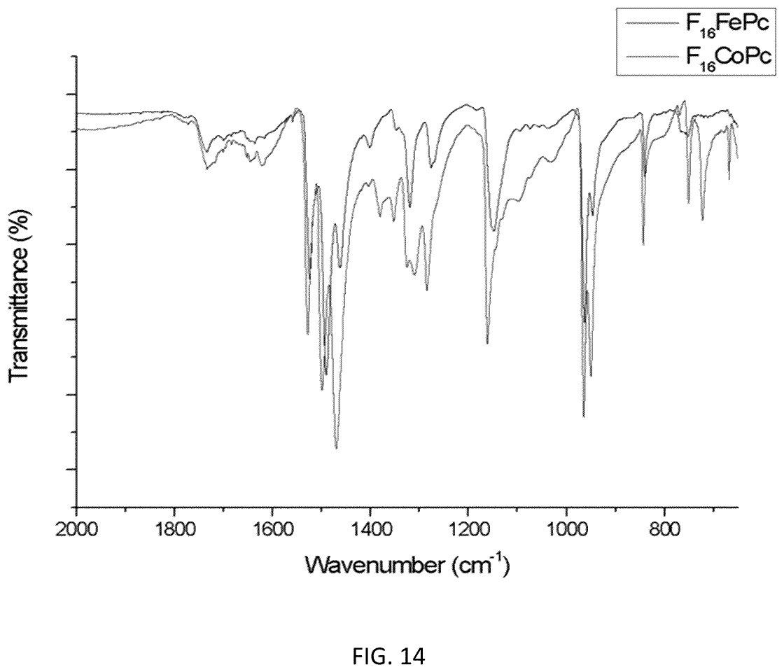

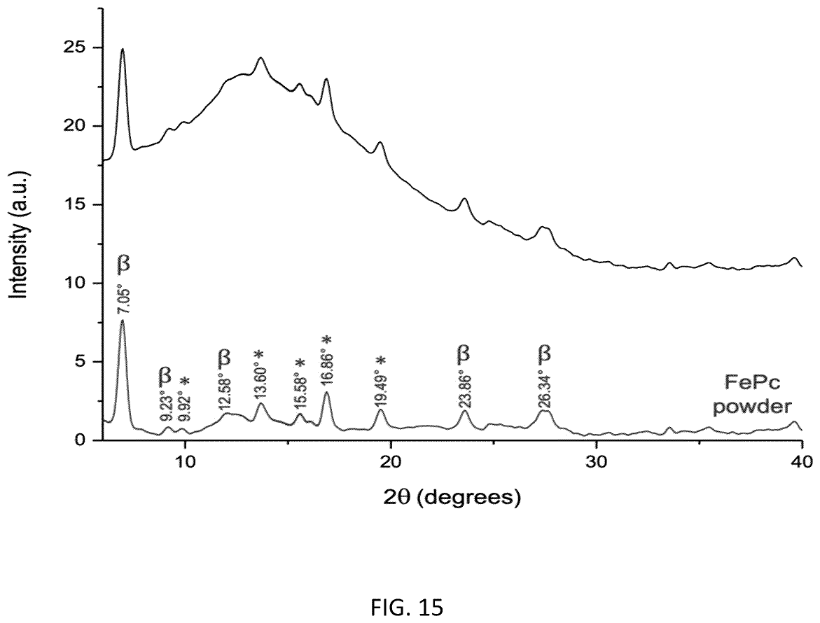

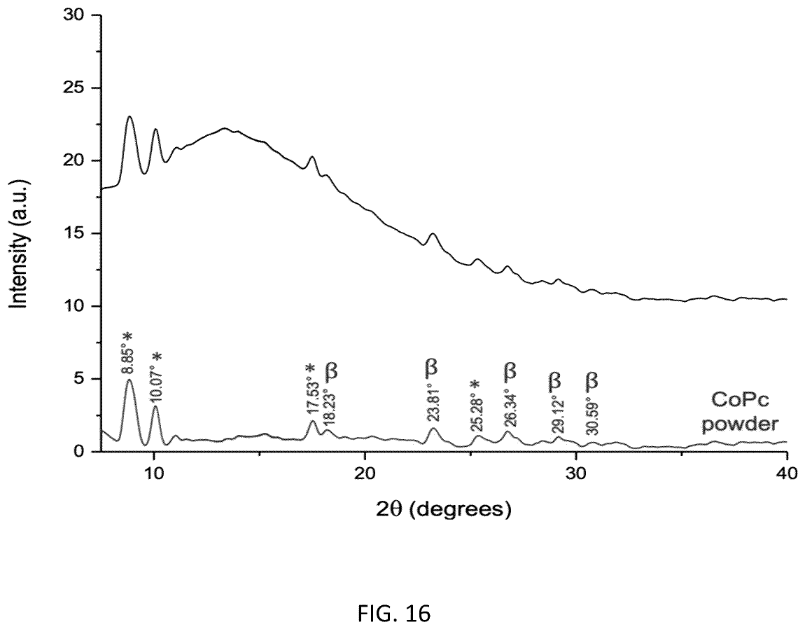

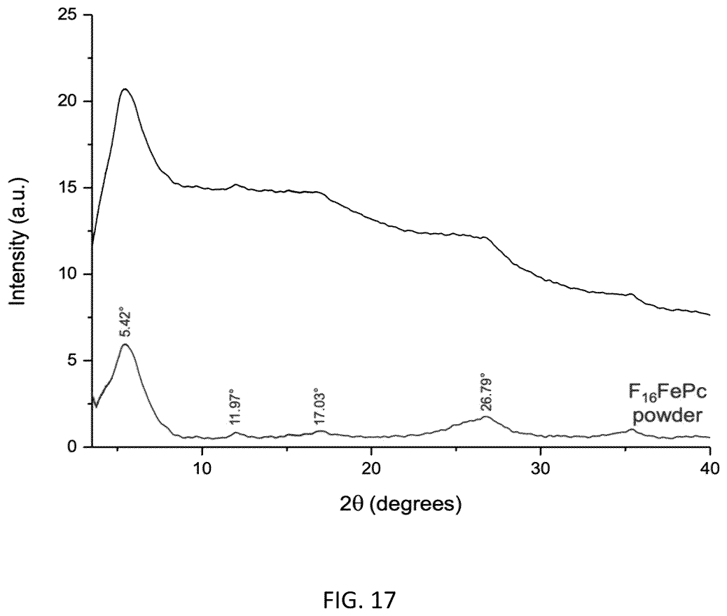

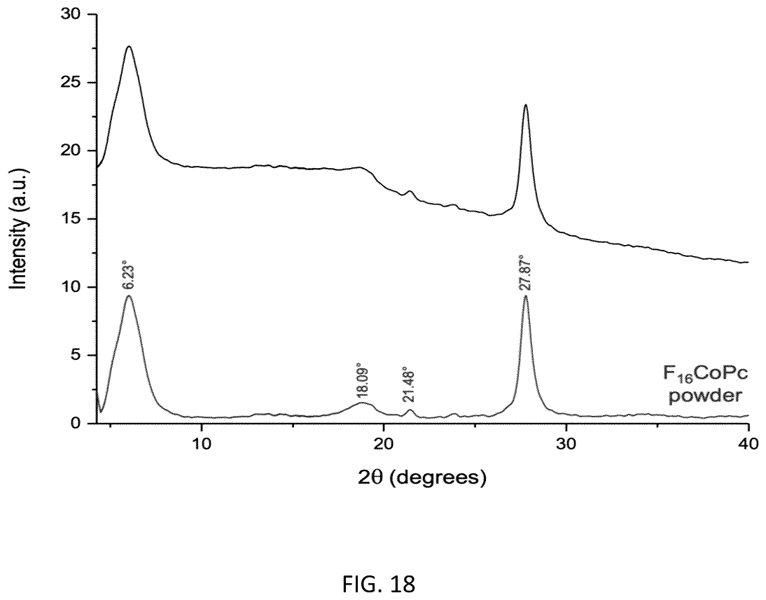

A modified procedure was developed based on the synthesis reported by Rothenberg et al. (2019, Appl. Organomet. Chem. 33: 1-7). Preparing these types of phthalocyanine systems was achieved by reacting commercially available phthalonitrile (1,2-dicyanobenzene) derivatives with metal acetate salts through a cyclotetramerization (template) reaction at high temperatures (Denekamp et al., 2019, Appl. Organomet. Chem. 33: 1-7; Kadish et al., 2012, The Porphyrin Handbook: Phthalocyanines: Synthesis. 15: 61-124). Isolation of the metal complexes involved washing the as-obtained powders with water to remove unreactive metal acetate salts, followed by: (a) washing with warm ethyl alcohol to remove unreacted starting material in the case of unsubstituted MPcs and (b) solid-liquid extraction with acetone in the case of F₁₆MPcs. (It is worth mentioning that 1,2-dicyanobenzene is considered hazardous by the 2012 OSHA Hazard Communication Standard (29 CFR 1910.1200), and thus must be handled with care.) Unsubstituted MPcs were prepared with a 4:1 (ligand: metal) ratio, where none of the reagents were used in excess with respect to one another. F₁₆MPc derivatives were prepared by having an excess of metal acetate salt, that consumed completely the less reactive fluorinated phthalonitrile (see Scheme 1; Nicolai et al., 1999, Template Synthesis of Macrocyclic J Compounds. Wiley. 1-27. ISBN:9783527613809). After purification, all products were characterized by UV-vis spectroscopy, FT-IR, and X-ray powder diffraction (FIGS. 8-18).

### Synthesis of H₁₆FePc

A 10 mL round bottom flask was charged with 1,2-dicyanobenzene (512 mg; 4.0 mmol) and Fe(OAc)₂ was added (174 mg; 1 mmol). The vessel was capped with a rubber septum under argon atmosphere, and the septum secured with a metal clamp. The reaction was heated until 200° C. and left at this temperature for 8 hours, after which a dark-violet solid was obtained. After cooling at room temperature, the as-obtained solid was pulverized using a mortar and pestle and suspended in 100 mL of distilled hexane to remove unreacted 1,2-dicyanobenzene. The suspension was stirred for 15 minutes at room temperature and vacuum filtered. The solid was washed with ethyl alcohol (5×10 mL), and afterwards a second suspension in 100 mL nano-pure water was performed to remove unreacted Fe(OAc)₂, which was stirred for 15 minutes and filtered under vacuum. The purified product was dried in vacuo overnight, affording 293 mg of H₁₆FePc (52% yield based on 1,2-dicyanobenzene).

### Synthesis of F₁₆FePc

A 10 mL round bottom flask was charged with 3,4,5,6-tetrafluoro-1,2-dicyanobenzene (500 mg; 2.5 mmol) and Fe(OAc)₂ was added (435 mg; 2.5 mmol). The vessel was capped with a rubber septum under argon atmosphere, and the septum secured with a metal clamp. The reaction was heated until 250° C. and left at this temperature for 8 hours, after which a dark-violet solid was obtained. After cooling at room temperature, the as-obtained solid was pulverized using a mortar and pestle and suspended in 100 mL of distilled hexane to remove unreacted 3,4,5,6-tetrafluoro-1,2-dicyanobenzene. The suspension was stirred for 15 minutes at room temperature and vacuum filtered. A second suspension in 100 mL nano-pure water was performed to remove unreacted Fe(OAc)₂, which was stirred for 15 minutes and filtered under vacuum. The crude product obtained upon workup was submitted to extraction with distilled acetone. The dark-violet solid was dissolved in 200 mL acetone and stirred for 15 minutes, leaving behind a black coal-like powder precipitate in solution, which was removed by centrifugation. The centrifuged solutions were filtered prior to being collected in a 500 mL flame-dried round bottom flask; and then the solvent was removed under reduced pressure. The purified product was further dried in vacuo overnight, yielding 221 mg of F₁₆FePc (41% yield based on 3,4,5,6-tetrafluoro-1,2-dicyanobenzene).

### Synthesis of F₁₆CoPc

A 10 mL round bottom flask was charged with 3,4,5,6-tetrafluoro-1,2-dicyanobenzene (500 mg; 2.5 mmol) and Co(OAc)₂ was added (623 mg; 2.5 mmol). The vessel was capped with a rubber septum under argon atmosphere, and the septum secured with a metal clamp. The reaction was heated until 250° C. and left at this temperature for 8 hours, after which a dark-violet solid was obtained. After cooling at room temperature, the as-obtained solid was pulverized using a mortar and pestle and suspended in 100 mL of distilled hexane to remove unreacted 3,4,5,6-tetrafluoro-1,2-dicyanobenzene. The suspension was stirred for 15 minutes at room temperature and vacuum filtered. A second suspension in 100 mL nano-pure water was performed to remove unreacted Co(OAc)₂, which was stirred for 15 minutes and filtered under vacuum. The crude product obtained upon workup was submitted to extraction with distilled acetone. The dark-violet solid was dissolved in 200 mL acetone and stirred for 15 minutes, leaving behind a black coal-like powder precipitate in solution, which was removed by centrifugation. The centrifuged solutions were filtered prior to being collected in a 500 mL flame-dried round bottom flask; and then the solvent was removed under reduced pressure. The purified product was further dried in vacuo overnight, yielding 121 mg of F₁₆CoPc (23% yield 3,4,5,6-tetrafluoro-1,2-dicyanobenzene).

### Synthesis of Nanowires and Device Preparation

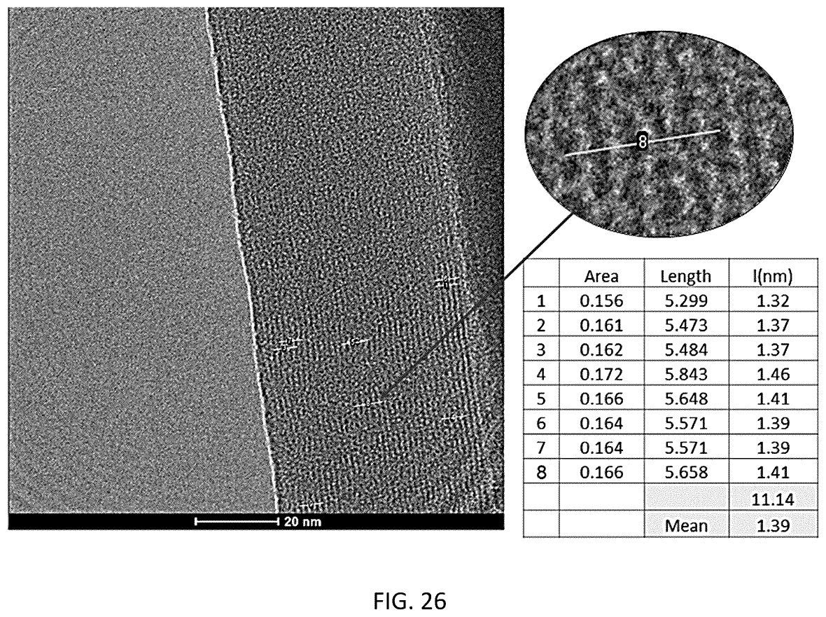

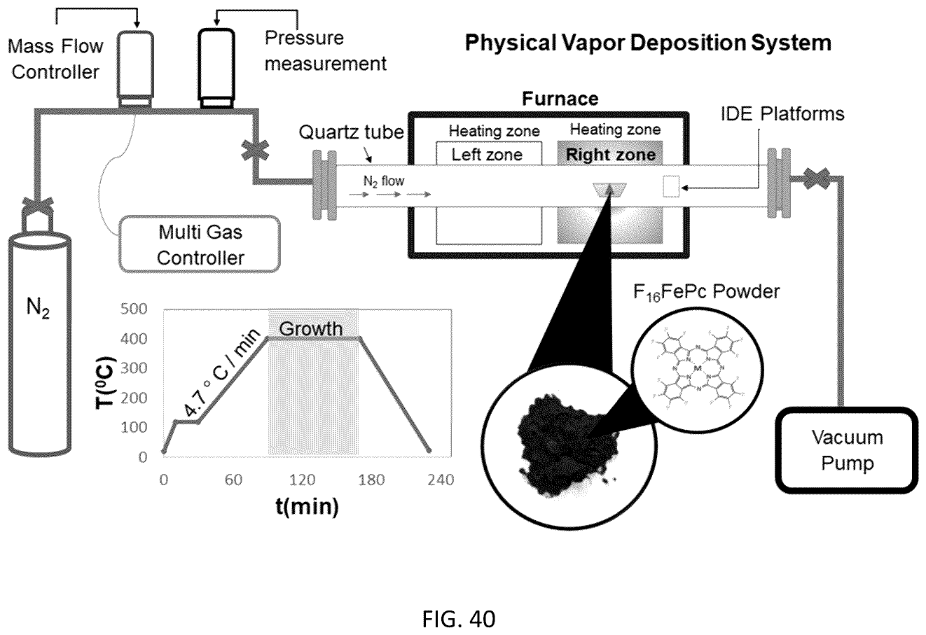

A PVD procedure was developed based on ones reported by Wang et al. (2017), Liu et al. (2015, Nanotechnology. 26: 225601-225610), and Tong et al. (2006, J. Phys. Chem. 110: 17406-17413), respectively (see FIG. 40). Practice of this procedure enabled gas sensor devices to be produced in one step based on FₓMPc nanowires because it promotes direct growth of the active nanowires on gold interdigitated electrodes as was previously reported by Fleet et al. (2017; see FIG. 26).

Successful growth of nanowires from previously synthesized FₓMPc powders by PVD was achieved through optimization of several parameters: carrying gas flow, temperature of evaporation/sublimation, interdigitated electrodes (IDE) platform temperature, physical position within the gas reactor and adequate time of growth. To fabricate the F₁₆FePc nano-wire sensor device, ˜20 mg of previously synthesized, purified, and powdered F₁₆FePc precursor was introduced into a 5 cm diameter 1.2 m long quartz tube reactor in the middle of the right side of a dual oven (MTI Corporation, Model OTF-1200X-II). The IDE platforms and other substrates were placed 12.5 cm from the precursor (at the end of the right zone). The reactor was closed and evacuated to 1.1×10⁻² Torr residual pressure with a mechanical pump (Trivac D 16 B). During the PVD procedure, the temperature was raised to 120° C. and kept constant during 20 minutes, then at a rate of 4.7° C./min, the temperature was raised to 400° C. and maintained stable for 80 min. Finally, the reactor was let to cool to room temperature. Throughout the experiment, a constant flow of nitrogen (UHP 99.999%) was maintained at 100 sccm rate; for this purpose, a MKS 1179C Mass Flow Controller was used connected to a MKS 647C Multi-Gas Controller, and the pressure was also monitored at 5 Torr inside the reactor with an Inficon PSG55x Vacuum Gauge.

The IDE platform position in the furnace during growth controls the kind of nanostructures formed, resulting in nanowires (of variable length), thin films or discrete nanoparticles. After optimization of the PVD parameters, a high yield growth of nanowires with multiple connections between contiguous electrodes is obtained with diameters below 200 nm.

### Gas Sensing Experiments

As-prepared sensor devices were tested in a gas testing chamber. The system included a sensor testing chamber (MMR Technologies LTMP) where the sensor devices became electrically connected with adjustable tungsten tips and tested at room temperature (24° C.±1° C.). A Keithley 6487 Picoammeter/Voltage Source was used as power source and electrical current measurements. Current measurements were done at 15-second intervals during exposure to a flow of air with and without polluting gas. The desired pollutant gas concentration was established by combining a flow of air (Compressed synthetic air tank-20.4% O₂) and a flow of test gas (100 ppm Ammonia/Nitrogen or 100 ppm NO₂/Nitrogen gas tanks) in the proper ratio to define the final concentration in parts of a billion by volume for a total gas flow of 500 sccm. Gas flows were set with MKS GE50A Mass Flow Controllers and monitored by MKS 946 Vacuum System Controller. Total moisture was determined by the carrier gas (0.036 ppm). No additional humidity was added.

To evaluate the sensor's response the electrical current intensity was measured as a function of time during exposure to an air flow with and without pollutant gas. The normalized sensor response was defined as S=|I−I0|/I0, where I is the electrical current intensity and I0 is the initial current intensity before the exposure of the sensor to the pollutant gas.

Powder X-Ray Diffraction. Powder X-ray diffraction data was collected in a Rigaku SuperNova, single-source micro-focus HyPix3000 diffractometer, with Cu Kα radiation at 300 K (1.5406 Å). Data reduction was performed using the program CrysAlisPro [CrysAlis PRO 1.171.39.46, Rigaku O D, 2018]. To assign the phases of the MPcs, PXRDs were generated from the experimental data published in the CSD. A table of all the 2theta (2θ) reflections for the phases was prepared and compared with the results obtained from the diffractograms. Data was processed using the Origin program, Version 9.4 (2017). OriginLab Corporation, Northampton, MA, USA.

The alpha (α) and beta (β) polymorphs of MPc are the two common structures reported (Milev, et al., J. Phys. Chem. 2008, 112 (14), 5339-5347). All modifications exhibited one-dimensional stacking of the molecules; however, the arrangement of the stacks with respect to one another differed. The α polymorph consists of columnarly arranged molecules, those of adjacent columns being aligned parallel to each other, whereas a nearly perpendicular arrangement is present in the β polymorph (Ji, et al., Cryst. Res. Technol. 2016, 51 (2), 154-159). In FePc, two polymorphs (α metastable and β stable) can occur; whereas five polymorphic modifications of CoPc are known; they are designated α, β, epsilon, pi and chi (Miley 2008). The α polymorph is triclinic, with space group P₁; whereas the β form is monoclinic, with space groups P2_{1/a}, P2_{1/c} and P2_{1/n} reported. Other modifications have been described in the literature related to the nanostructures thereof (Ji 2016; Tong et al., J. Phys. Chem. 2006, 110 (35), 17406-17413). The β modification is often converted to the α modification by dry grinding in the presence of additives and heat (Ballirano, et al., J. Am. Chem. Soc. 1998, 120 (49), 12798-12807). All modifications can be transformed into the most stable form by heating in a high-boiling, inert solvent or through annealing (Heutz, et al., J. Phys. Chem B. 2000, 104 (30), 7124-7129). During synthesis of the powders, the β modification was primarily formed, as observed from the diffraction patterns of FePc and CoPc. Some unidentified phases could also be present but are lost and non-existent in the nanostructures formed from these materials thereof. Thus, the most stable modification at high temperatures was formed, as expected.

### Fabrication of Gold Interdigitated Electrodes (IDE)

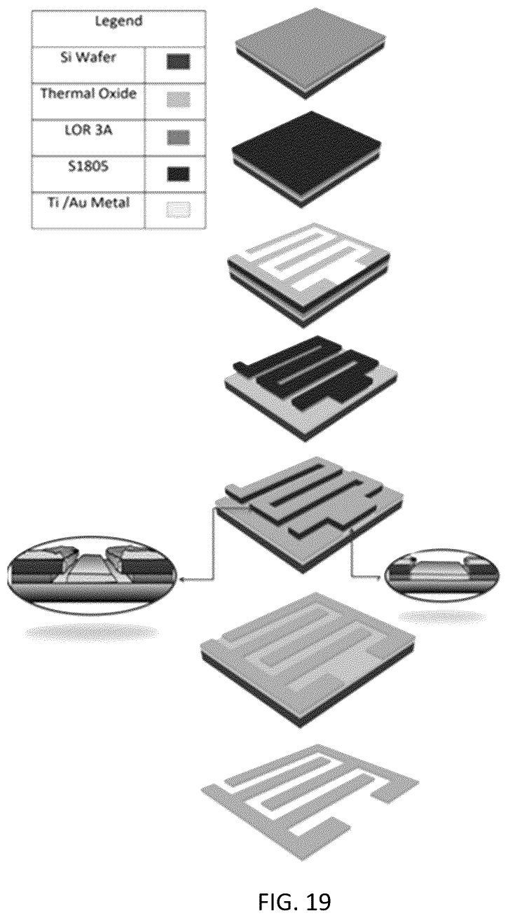

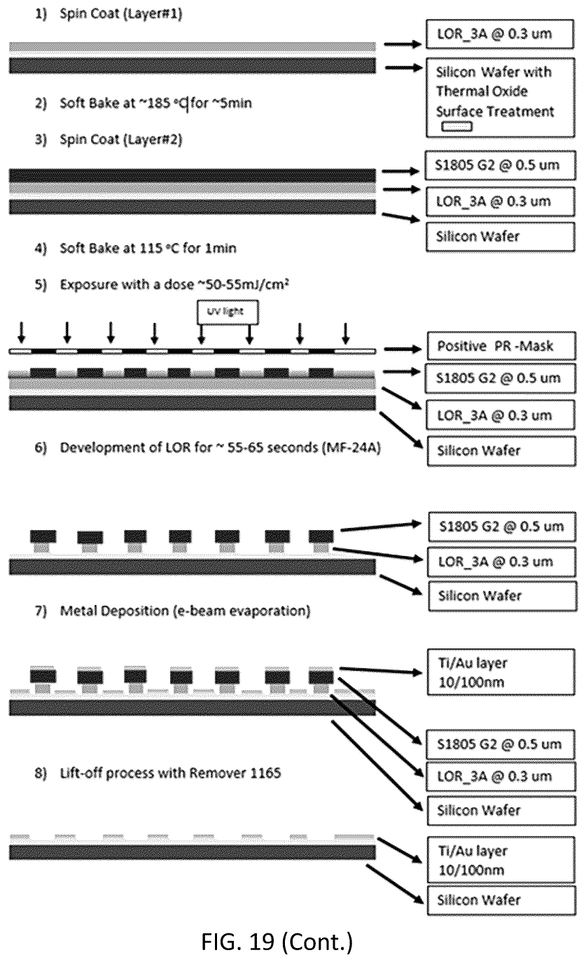

The IDE substrate was fabricated by employing conventional photolithographic processes (see FIG. 19). A 3-inch in diameter silicon wafer <100>SSP with 380 μm in thickness and 300 nm of thermal oxide was used as the starting substrate (University Wafer). LOR 3A (LOR and PMGI Resists, MicroChem, Westborough, MA) and S1805 (Microposit S1800 Series Photoresist, Marlborough, MA) were used for the bilayer resist method. The desired pattern was transferred onto the PR by UV exposure using a dark field quartz photomask (4″×4″×0.060″) with a critical dimension/Tolerance of 2.0 μm+/−0.25 μm (Photo Sciences, Torrance, CA). UV exposure of the PR was done with a MJB3 Mask Aligner (SUSS MicroTec, Germany). PR and LOR development was performed by submerging the wafer completely in a glass dish containing MF-24A without agitation. To remove any residual photoresist in the critical features, a de-scumming step was performed in an oxygen plasma for 30-60 seconds (50 watts, March Instrument Plasmod Plasma Reactor, Concord, CA). Metal deposition was performed with an electron beam evaporator (Temescal FC-1800 E-Beam Evaporator, Santa Clara, CA). Deposited thicknesses were 10 nm of Ti and 100 nm of Au. For the lift-off process the wafer was submerged in Remover 1165 (MicroChem, Westborough, MA) at 70° C. for 30 minutes followed by deionized water submersion in two consecutive baths and dried with a nitrogen gun.

### Nanofabrication of MPc Nanowires on Top of Gold IDE Through PVD

Scanning Electron Microscopy (SEM). Model Thermo Scientific Helios 5 DualBeam FIB-SEM.

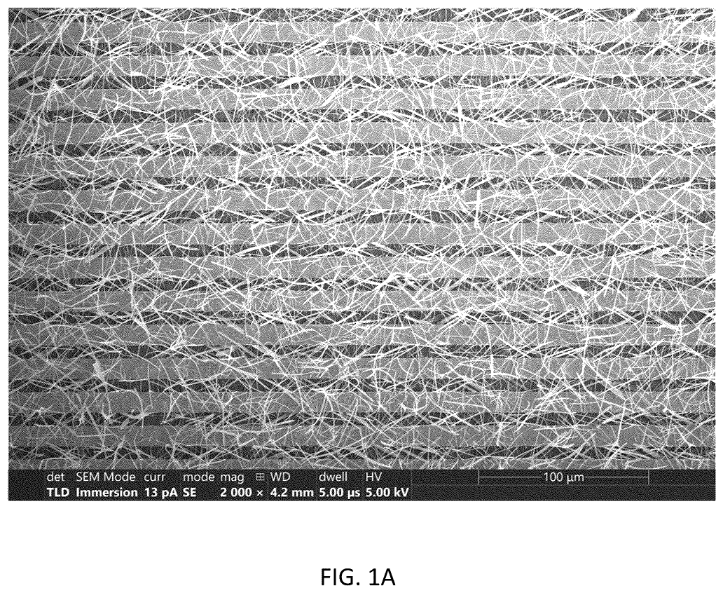

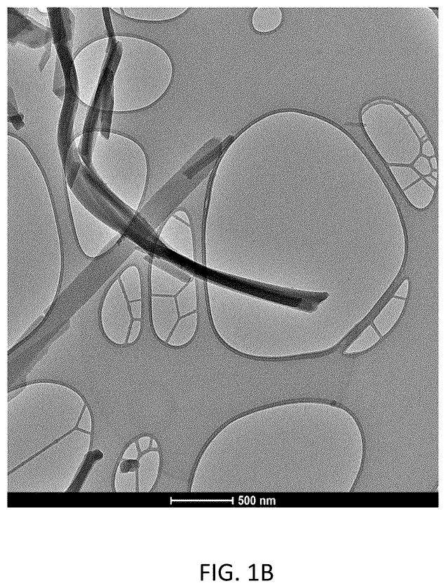

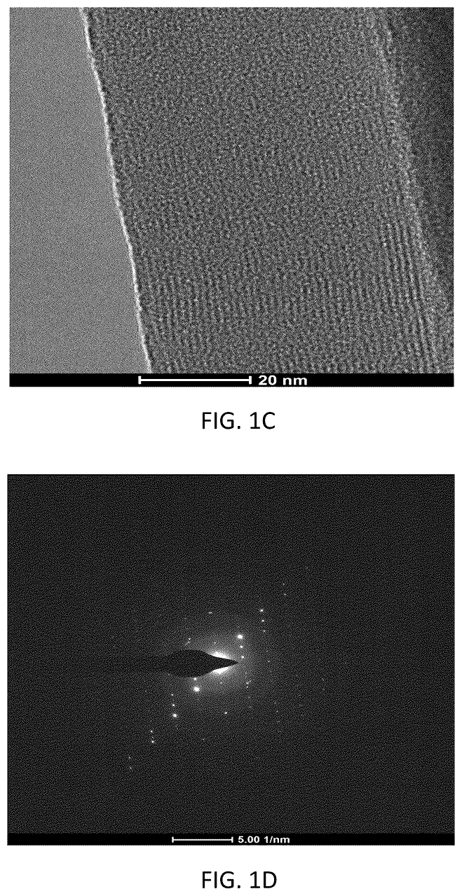

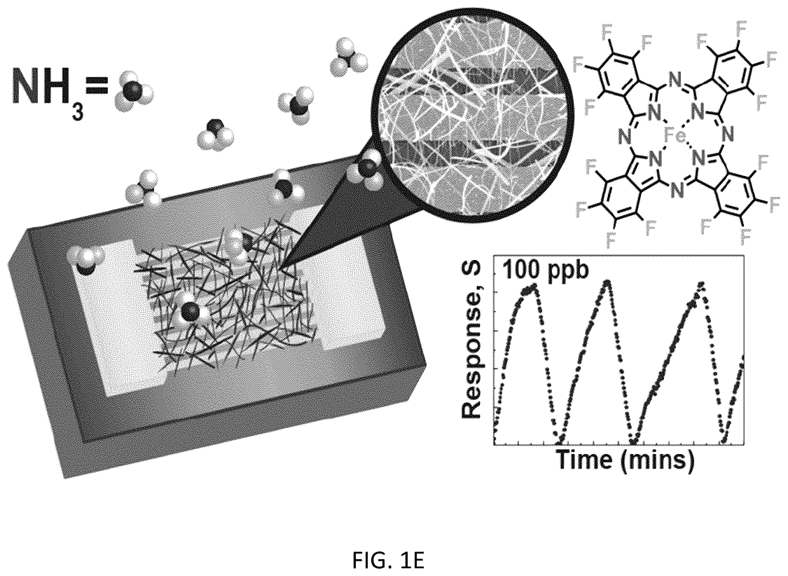

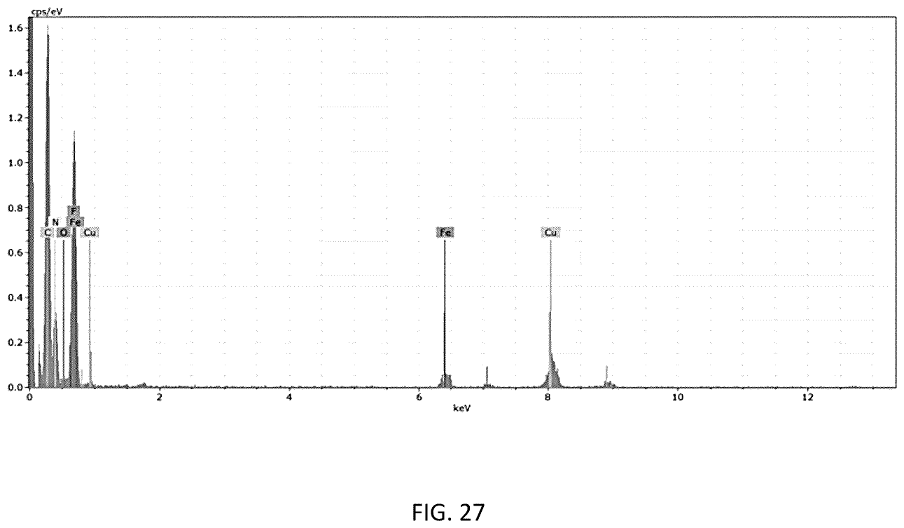

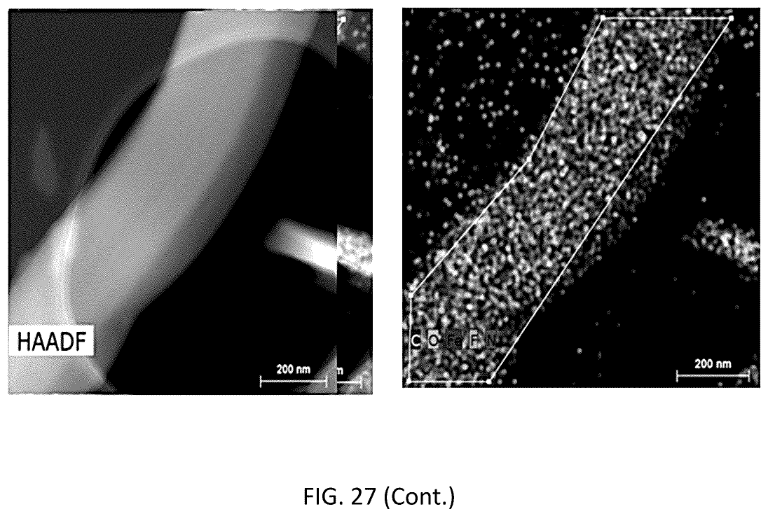

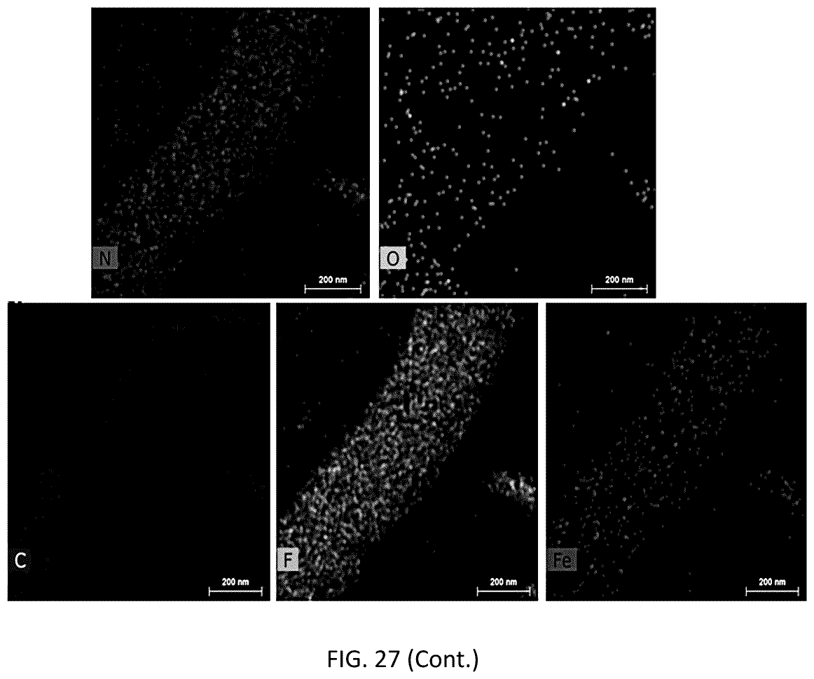

SEM images of the as-grown F₁₆FePc nanowires on interdigitated gold electrodes showed preferential growth of the nanowires at the gold electrode surface (see red circles in FIG. 27). Nanowires with diameters <100 nm and belts of larger width but <100 nm thickness were observed in FIG. 27. For SEM images, low resolution images with 5 kV beam and higher resolution with 20 kV beam are shown in in FIGS. 1, 27, and 28, respectively. Details about magnification, beam intensity, acceleration voltage, are included in each figure.

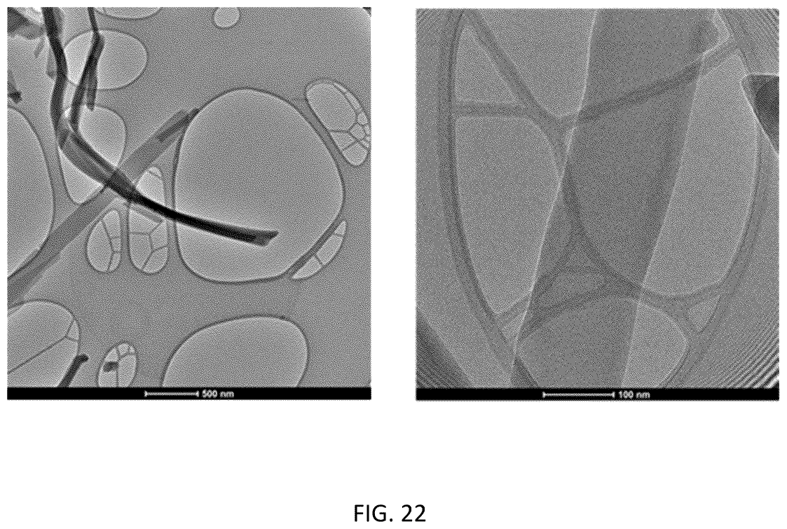

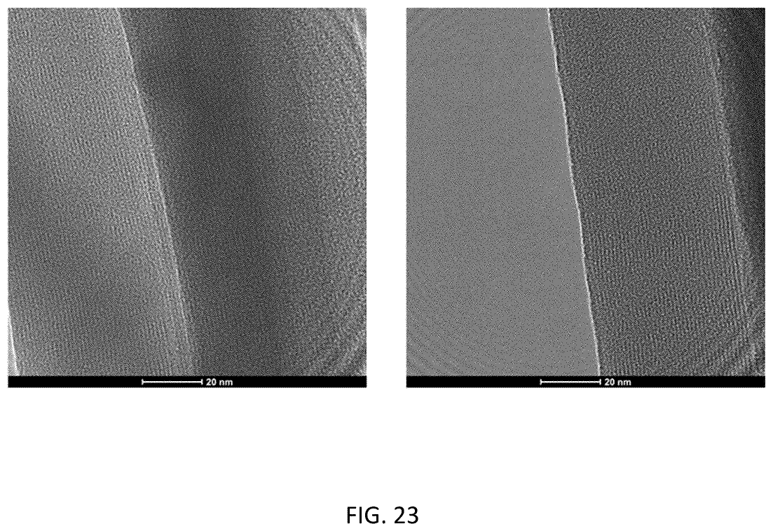

Transmission Electron Microscopy (TEM). Instrument Model: Thermo Scientific Talos F₂₀₀X equipped with a four-quadrant 0.9-sr energy dispersive X-ray spectrometer (EDS) for elemental mapping. TEM images (FIGS. 22 and 23) were consistent with SEM and AFM findings by showing single nanowires and larger belts with >100 nm thickness, and bundles.

### Fast Fourier Transform (FFT) Measurements

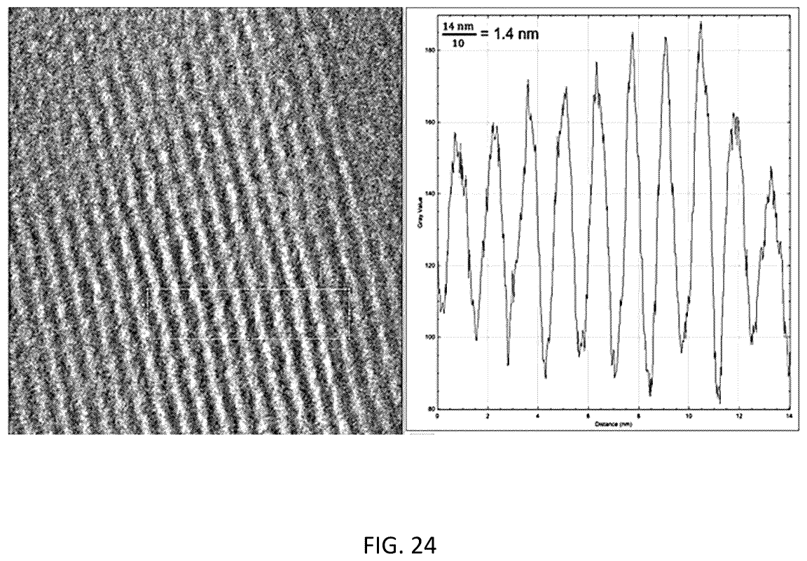

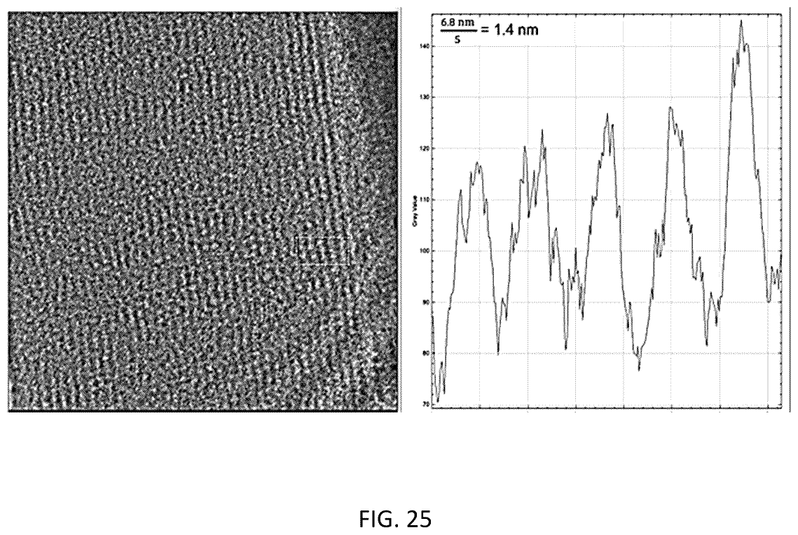

Using the image processing program ImageJ, FFT measurements were performed to distinguish regions in the as-obtained TEM images (Schneider, et al., Nature Methods. 2012, 9, 671-675; Abramoff, et al., Biophotonics Int. 2004, 11 (7), 36-42). Spatial calibration was carried out using the scale bar at the bottom of the images (FIG. 23). After the distance:pixels ratio was calculated, a profile plot was generated using a fixed set of planes outlined as yellow boxes in FIG. 24 and FIG. 25. The cycles were manually counted, and the distance was divided by the number of cycles on the plot (shown in red at the top-left corner of each plot).

Using the same program but the “Roi Manager” tool, the distance between the planes was estimated knowing the scale of the image (FIG. 23). To get an average, 8 measurements of different parts of the image and 5 parallel planes were considered, the average was 1.39 nm.

### Energy Dispersive X-ray Spectroscopy (EDS) and Atomic Force Microscopy (AFM)

Spectra and mappings of the different elements in a nanowire supports F₁₆FePc chemical composition as shown in FIG. 27.

TABLE 1
Normalized quantitative weight percentages for the elements
in the yellow region of the F₁₆FePc nanowire.

| | | | | | | Error in |
|---|---|---|---|---|---|---|
| | | | | [norm. | [norm. | wt. % |
| Element | Series | Net | [wt. %] | wt. %] | at. %] | (3 Sigma) |
| Carbon | K-series | 6762 | 69 | 69 | 78 | 6.8 |
| Oxygen | K-series | 225 | 1 | 1 | 1 | 0.4 |
| Iron | K-series | 471 | 4 | 4 | 1 | 0.8 |
| Fluorine | K-series | 2958 | 18 | 18 | 12 | 2.0 |
| Nitrogen | K-series | 1045 | 18 | 18 | 8 | 1.0 |
| | | Sum: | 100 | 100 | 100 | |

AFM scanning was made with a Digital Instruments Nanoscope IIIA AFM in tapping in air with Bruker MESP cantilever. Data was processed using Nanoscope Analysis 1.7 software.

### Raman Spectroscopy

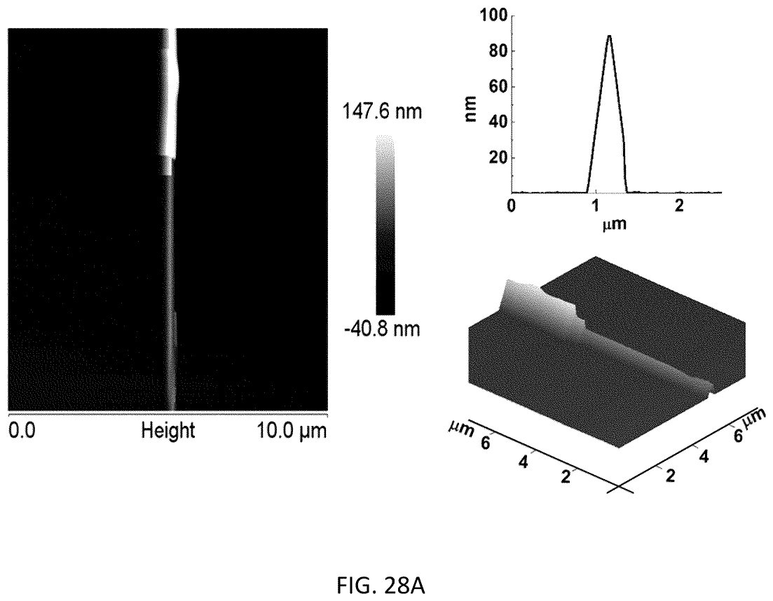

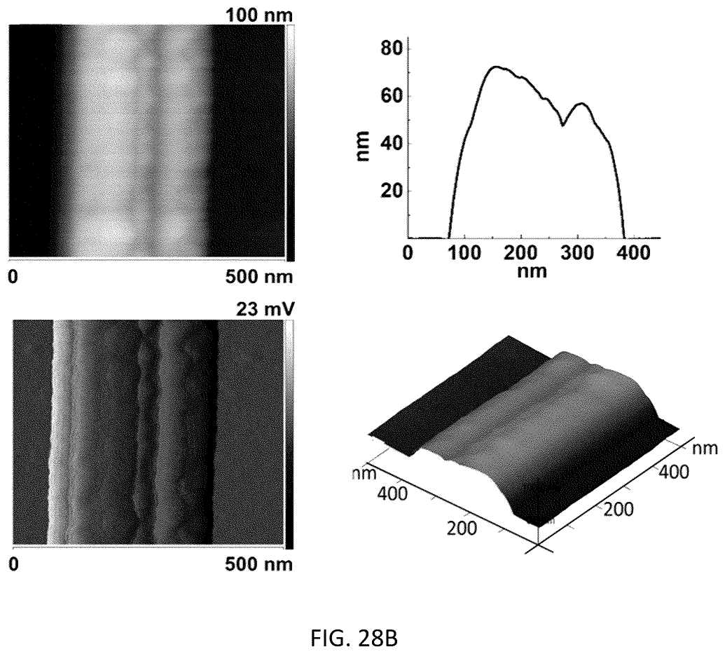

Raman spectra of as prepared FePc, F₁₆FePc and F₁₆CoPc materials are shown in FIGS. 28A-28B. Many of unsubstituted metallic phthalocyanines and fluorosubstituted phthalocyanines such as MPc (M=Co, Cu, Fe, Ni, Mn) among others, are flat molecules of group D4h symmetry and their vibrational modes corresponds to:

Γvib=14 Alg+13 A2g+14 B1g+14 B2g+13 Eg+6 Alu+8 A2u+7 Blu+7 B2u+28 Eu, where the active modes in Raman are Alg, B1g, B2g (in the plane) and Eg (out the plane).

Differences in spectral behavior of the different MPc was due to the influence of the central cation. In the group of bands between 1350 cm⁻¹ and 1500 cm⁻¹, a slight displacement product of the metal ion was observed (Basova, et al, Sens. Actuators B. Chem. 2016, 227, 634-642; Liu, et al., Spectrochim. Acta A Mol. Biomol. Spectrosc. 2007, 67 (5), 1232-1246). As disclosed herein, in F₁₆FePc this displacement was 1531 cm⁻¹, in F₁₆CoPc it was 1528 cm⁻¹ and in FePc it was 1534 cm⁻¹.

Insertion of sixteen F substituents in MPc entails to a change in intensities and wavenumbers of the vibrations due to the contribution of C—F vibrations, which is noticeable in the bands ranging from 1450 cm⁻¹ to 1640 cm⁻¹ that are associated with the stretching vibrations of C═N and C═C in the benzene rings. Another group of bands from 600 cm⁻¹ to 1250 cm⁻¹ is also associated with macroring or isoindole deformations due to the contribution of C—F vibrations (Klyamer, et al., J. Mol. Struct. 2019, 1189, 73-80.

Raman data was obtained using a T64000 Raman spectrometer from JY-Horiba, with triple monochromator in subtractive mode equipped with a CCD detector. For focus, an Olympus microscope with 80X objective in backscattering mode was used. The laser was Coherent Argon Innova 70C, using 514.53 nm and 5 mW on the sample.

The data acquisition was made during 120 s within a range between 10 to 2000 cm 1 on A1 substrates. The vibrations observed in our data are assigned according to data found in the literature (see, e.g., Basova 2016; Liu 2007; Klyamer 2019).

### Powder X-Ray Diffraction

The formation of thin films composed of nanowires through PVD is a complex process that is influenced by many factors such as the material's properties, deposition parameters, and external constraints resulting in multiple film microstructures ranging from single crystals to polycrystalline and amorphous films. Nanowire growth on substrates disclosed herein was performed at high temperatures above 400° C.; at these temperatures, molecules have an increased kinetic energy and can easily migrate to lower energy sites, creating a high amount of nucleation points and resulting in polycrystalline structures with various crystallite sizes, most in the nm range with wire morphology.

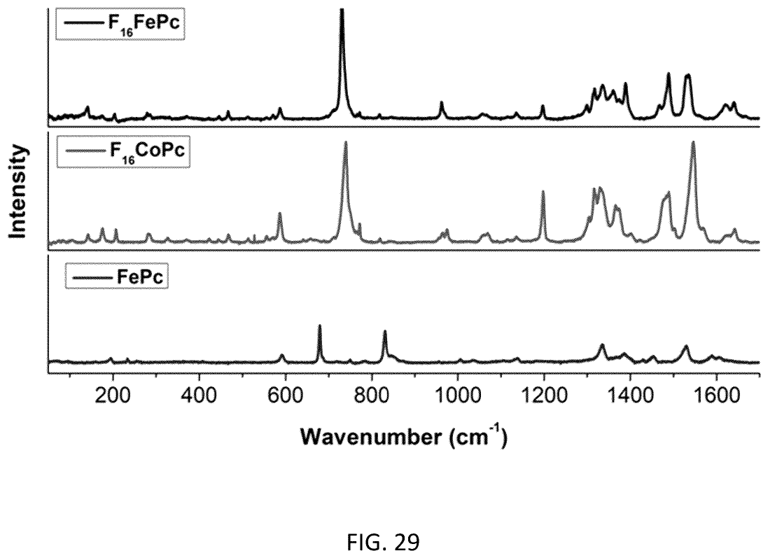

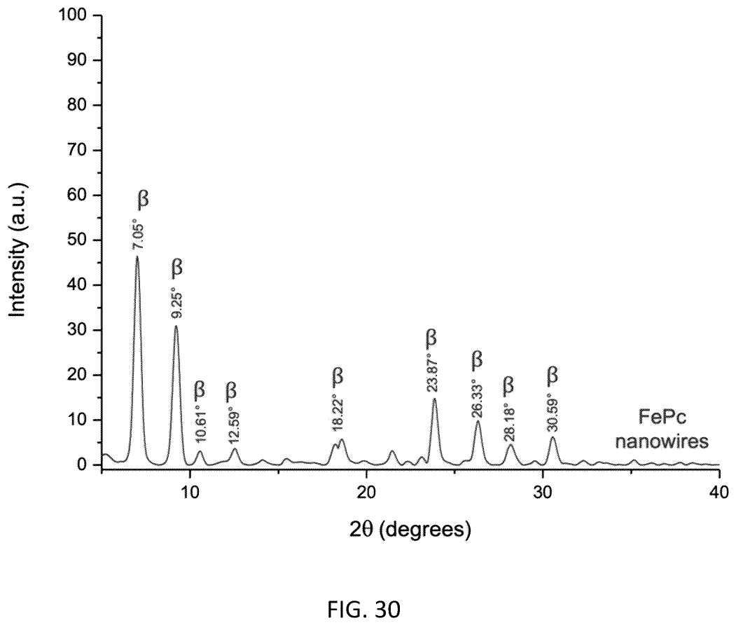

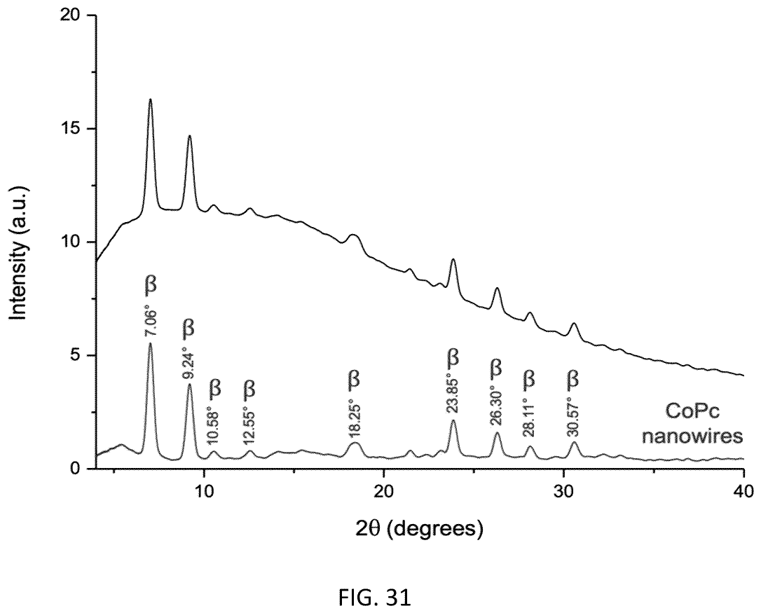

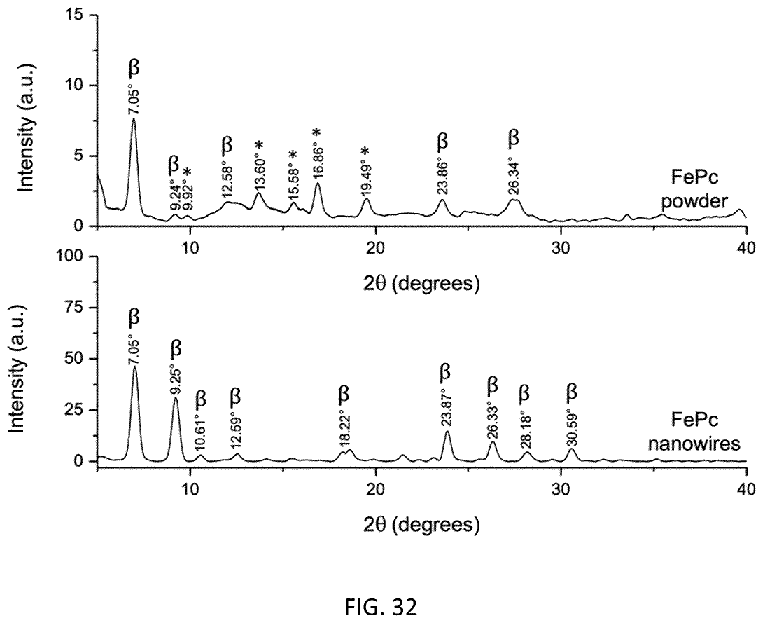

During the synthesis of these nanostructures, the most stable modification at high temperatures was formed; in the case of CoPc and FePc this was the β-modification. FePc nanowires shown in FIG. 29 showed characteristic XRD peaks at 20=7.05° and 9.25° corresponding to inter-atomic plane separations of β-FePc, d(100)=12.49 Å and d(−102)=9.55 Å, respectively. CoPc nanowires shown in FIG. 31 also possessed characteristic XRD peaks at 20=7.06° and 9.24° C. orresponding to the inter-atomic plane separations of β-CoPc, d(100)=12.49 Å and d(−102)=9.55 Å, respectively. In the pattern of CoPc and FePc nanowires grown using the method disclosed herein, locations of the peaks were somewhat different from the powder precursor which contain mostly the β-MPc phases and some which could not be identified (FIG. 30 and FIG. 32).

A search for F₁₆MPc diffraction data performed in the Cambridge Structural Database (CSD) revealed a total of three structures of F₁₆MPc (M=Co, Cu, Zn). All these compounds crystallize in the triclinic P₁ space group and contain an antiparallel arrangement of molecules isostructural to the α and β polymorph in unsubstituted systems. F₁₆CoPc, specifically, displays characteristic XRD peaks at 20=6.32° and 28.19º (Jiang, et al., Sci. Rep. 2014, 4, 7573-7578). Basova et al. has also reported the powder pattern for F₁₆CoPc which reveals Bragg peaks at 2θ=6.20° and 12.14°, corresponding to the (001) and (002) planes. Peaks with a very low intensity were observed at 11.96°, 16.93° and 22.58° F. or the F₁₆ZnPc system, corresponding to the (002), (003), and (004) planes respectively (Klyamer, et al., Sensors. 2018, 18 (7), 2141-2148). There is no F₁₆FePc diffraction data (nor of F₁₆MnPc or F₁₆NiPc) reported to date in the CSD, to our knowledge. A recent publication by Denekamp et al. shows diffraction peaks of 2θ=27.70° and 27.65° for F₁₆CoPc and F₁₆FePc, respectively (Denekamp, et al., Appl. Organomet. Chem. 2019, 33, e4872).

Table 2 presents a summary of the fast time constants for each tested ammonia concentrations and the R² values of the fittings.

TABLE 2
τ_{1F} and R² values for different NH₃ concentrations

| | 100 ppb | 500 ppb | 1 ppm | 2 ppm | 3 ppm | 4 ppm |
|---|---|---|---|---|---|---|
| τ_{1F} (hrs) | 2.253 | 0.395 | 0.408 | 0.128 | 0.090 | 0.058 |
| R² | 0.998 | 0.995 | 0.995 | 0.993 | 0.993 | 0.991 |

### Reproducibility

F₁₆FePc: 12 different sensor prototypes with nanowires were tested: three on an IDE platform from Micrux company, and 9 on IDE platforms. In 3 of them, the testing was repeated more than 10 times, subjecting them to different NH₃ concentrations from 0.04 to 5 ppm in N₂ and Air. Measurements were done applying voltages of 1V or 5V.

F₁₆CoPc: 7 different sensor prototypes, testing in one was repeated 6 times. Tests were made with N₂ and Air as inert carrying gases, NO₂ and NH₃ as reacting gases from 0.1 to 10 ppm.

FePc: 4 different sensor prototypes, testing in one was repeated 4 times. Tests were made with N₂ and Air as inert carrying gases, NO₂ and NH₃ as reacting gases from 0.04 to 1 ppm.

Results showed that each as prepared sensor baseline current intensity varied as it depends on the density of grown nanowires and their electrical contacts. However, repetition of the gas testing procedure with the same sensor brings differences in the baseline current intensity below 10%

TABLE 3
Number of tested sensors and summary
of different experimental conditions.

| | | | | Gas |
|---|---|---|---|---|
| | # of similar | # of | | concentrations |
| Material | tested sensors | repetitions | Tested gases | tested |
| F₁₆FePc | 12 | 1-5 | NH₃ | 40 ppb-5 ppm |
| F₁₆FePc | 3 | 10 | NH₃, NO₂, | 40 ppb-25 ppm |
| | | | H₂, CO, CH₄ | |
| F₁₆CoPc | 6 | 1 | NH₃ | 100 ppb-10 ppm |
| F₁₆CoPc | 1 | 6 | NH₃, NO₂ | 100 ppb-10 ppm |
| FePc | 3 | 1 | NO₂ | 40 ppb-1 ppm |
| FePc | 1 | 4 | NH₃, NO₂ | 40 ppb-1 ppm |

### RESULTS

### Characterization of Complexes

As detailed hereinabove, synthesis of Pc metal complexes was performed at high temperatures and pressures in the solid state. Metal acetate salts were chosen because of their water solubility, which enabled their efficient removal by subsequent washing of the as-obtained powders. These were later extracted with acetone using Soxhlet and solvent removed in vacuo to yield purple microcrystalline MPc complexes.

Absorption spectroscopy is a powerful tool for the identification of different systems to characterize MPc complexes. The advantages of using absorption spectroscopy to characterize these compounds are numerous and effects like metal ion coordination in the cavity, peripheral substituents and axial coordination can be studied in detail. Elucidation of the molecular structure and monitoring reactions by means of absorption spectroscopy can be challenging in some instances, however, because in solution they are prone to aggregation at moderate-to-high concentrations. The molar extinction coefficients of these compounds are very large (on the order of 105 M⁻¹ cm⁻¹) and most measurements had to be taken at very low concentrations (10⁻⁶ M). Absorption spectroscopy in the UV-Vis region showed characteristic x-x transitions at 323 nm and 322 nm for F₁₆FePc and F₁₆CoPc, and metal-x transition in the visible region at 624 nm and 621 nm for F₁₆FePc and F₁₆CoPc, respectively. The UV band of both complexes is of lower energy than the UV band of the initial phthalonitrile starting material, indicative of increased conjugation and macrocycle formation. Characteristic vibrational bands were observed in the IR like bridge N vibrations at 1491 cm⁻¹ and 1500 cm⁻¹ for F₁₆FePc and F₁₆CoPc, and metal-n stretching at 963 cm⁻¹ and 964 cm⁻¹ for F₁₆FePc and F₁₆CoPc, respectively.

In powder X-ray diffraction (XRD) patterns, the α and β polymorphs of MPc are the two common structures reported (Milev et al., 2008, J. Phys. Chem. 112: 5339-5347.). All modifications exhibited one-dimensional stacking of the molecules; however, the arrangement of the stacks with respect to one another differed. The α polymorph consists of columnar arranged molecules, those of adjacent columns being aligned parallel to each other, whereas a nearly perpendicular arrangement was present in the β polymorph (Ji et al., 2016). In FePc, two polymorphs (α metastable and β stable) can occur, while five polymorphic modifications of CoPc are known; they are designated α, β, ε, τ and χ (Milev et al., 2008). The α polymorph is triclinic, with space group P₁; whereas the β form is monoclinic, with space groups P21/a, P21/c and P21/n reported. Other modifications have been described in the literature related to the nanostructures thereof (Tong et al., 2006; Ji et al., 2016). The β phase is often converted to the α phase by dry grinding in the presence of additives and heat (Ballirano et al., 1998, J. Am. Chem. Soc. 120: 12798-12807). All modifications can be transformed into the most stable form by heating in a high-boiling, inert solvent or through annealing (Heutz et al., 2000, Phys. Chem. B. 104: 7124-7129). During the synthesis of the powders, the β modification was primarily formed, as observed from the diffraction patterns of FePc and CoPc. Some unidentified phases could also be present but are lost and non-existent in the nanostructures formed from these materials thereof. Thus, the most stable modification at high temperatures was formed, as expected.

### MPc Nanowires Structure and Morphology

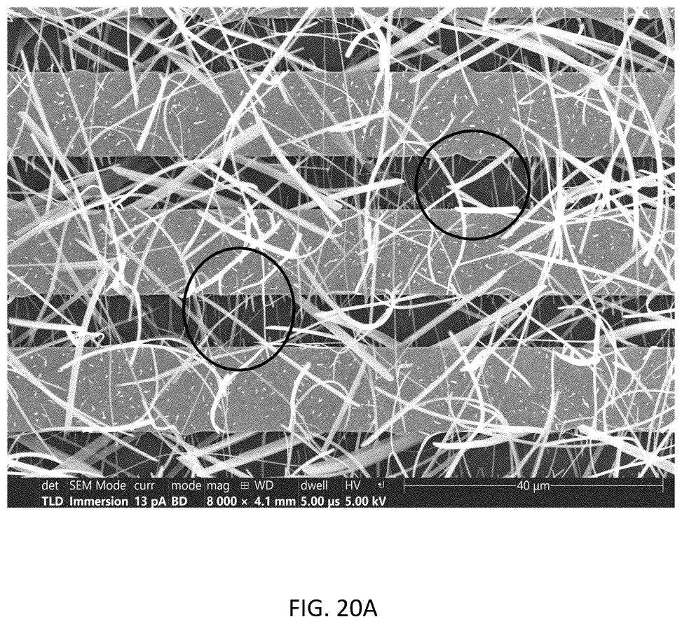

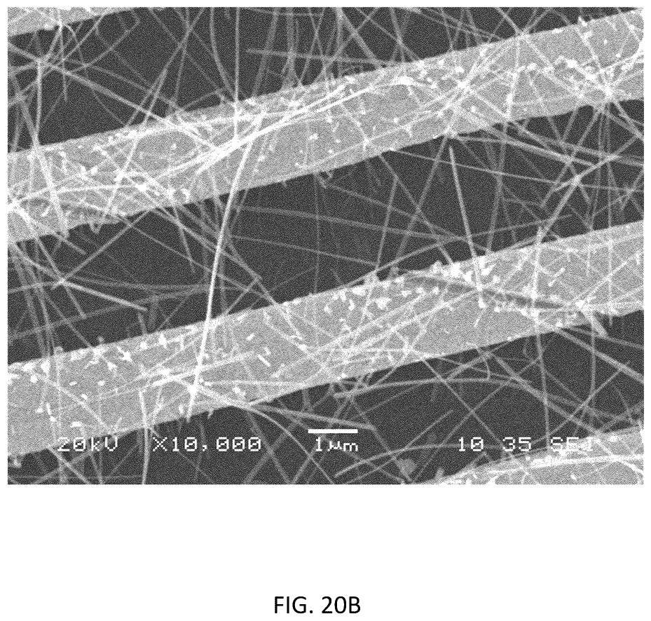

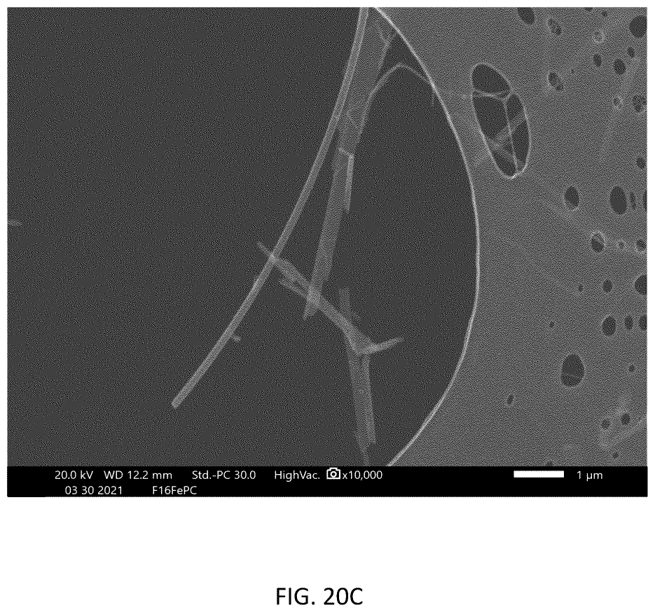

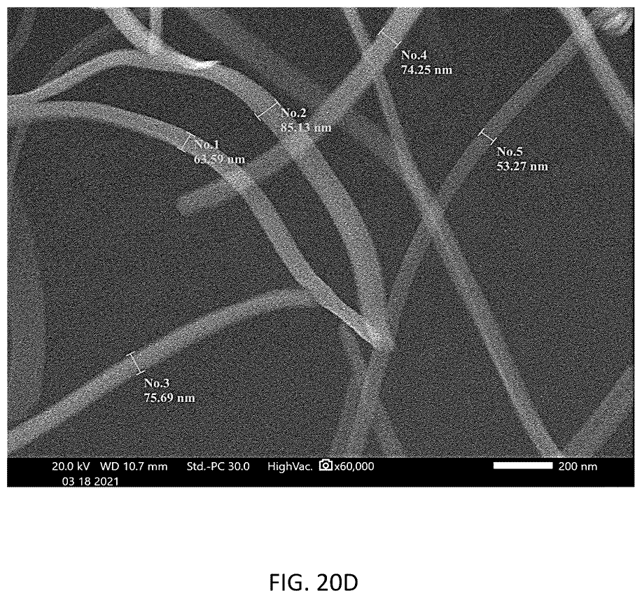

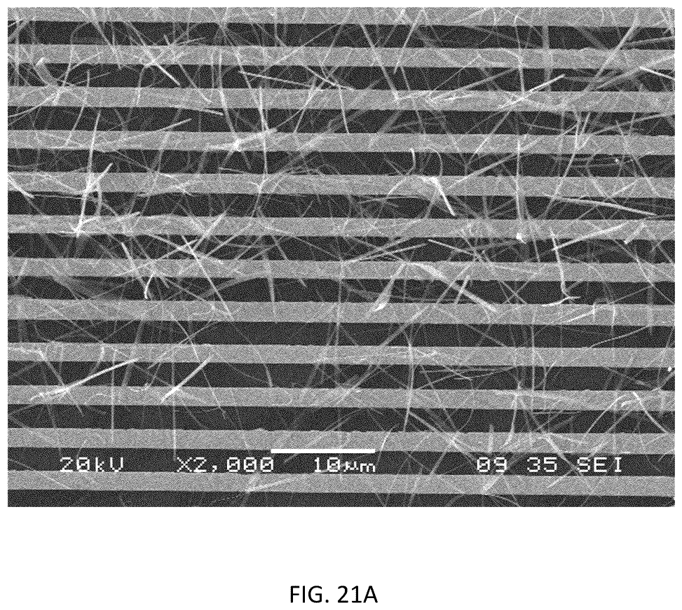

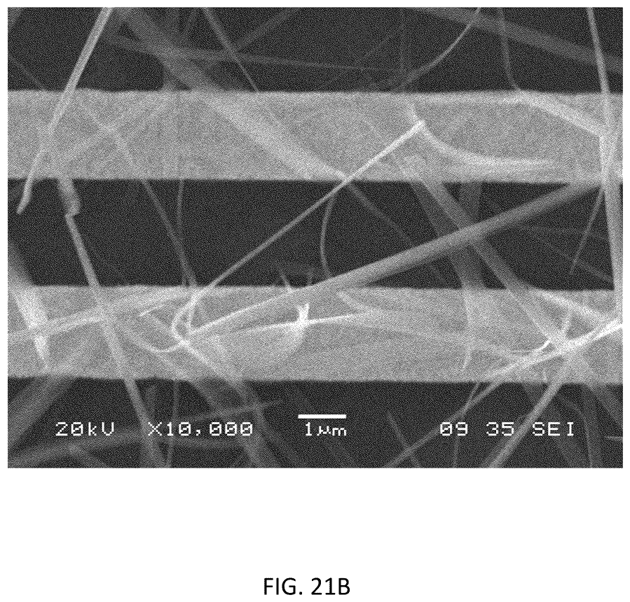

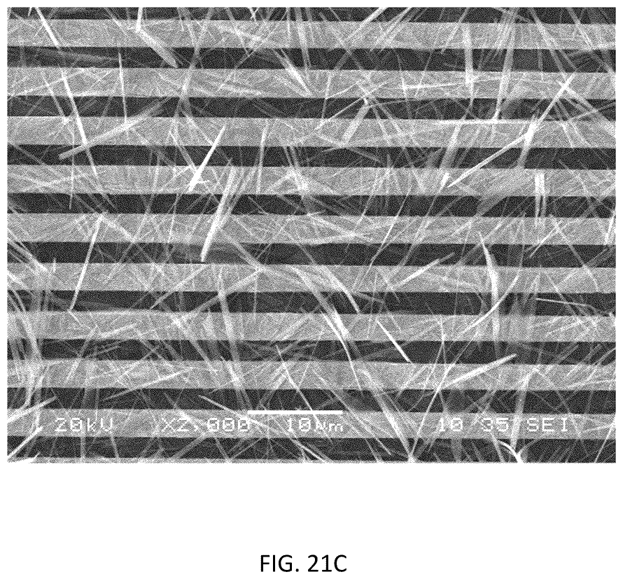

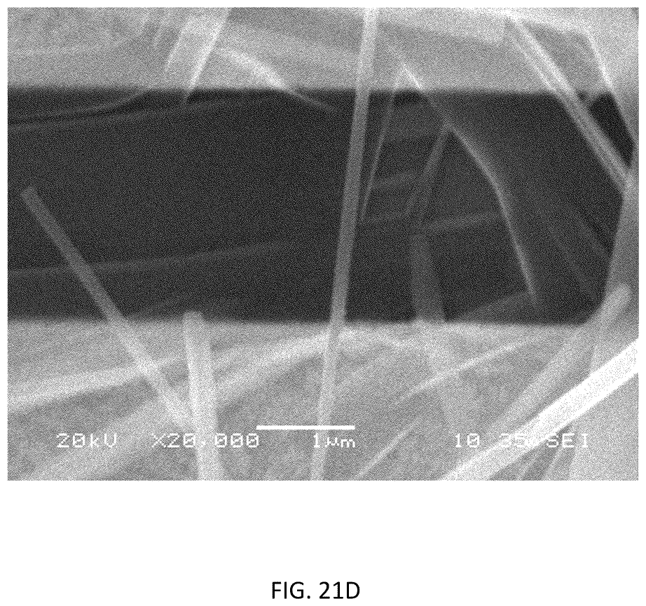

FIG. 1A shows a scanning electron microscope (SEM) image of as-grown nanowires on IDEs, as observed in the image a uniform coverage of the IDE is achieved. Wires' size distribution includes <100 nm wires, >150 nm belts and bundles (TEM images in FIG. 1B). FIG. 1C shows a high-resolution transmission electron microscope (HRTEM) image of a ˜54 nm F₁₆FePc wire. The crystal planes spanning the observed region confirmed highly crystalline quality also obtained in the electron diffraction pattern shown in FIG. 1D. Additional SEM and TEM images of F₁₆FePc and F₁₆CoPc nanowires are shown in FIGS. 20-23. Multiple measurements were performed on FIG. 1C that revealed a distance of ˜ 1.4 nm between crystalline planes (FIGS. 24-26). Spectra and mappings of the different elements in a selected nanowire supports F₁₆FePc chemical composition as shown in FIG. 27.

Optical microscopy inspection showed larger density of wires close to gold electrode areas, and in SEM closeup images (FIG. 20) preferential growth from the gold electrodes is shown with a large concentration of smaller size nanowires making direct contact between adjacent electrodes. The preferred formation of MPc nanowires directly on the surface of the gold electrodes was consistent with previous reports where the effect on nucleation upon the use of gold substrates for growing MPc nanostructures with a diversity of shapes was examined (see, Karan et al., 2008, J. Phys. Chem. C. 112: 2436-2447; Kothe et al., 2019, Langmuir. 35: 13570-13577.).

Atomic force microscopy (AFM) mappings of larger wires showed that larger structures are belts or bundles with thickness in the nanoscale. Before testing the sensors with target gases, Raman spectroscopy was also used for a complete characterization of the nanowires (FIGS. 28 and 29).

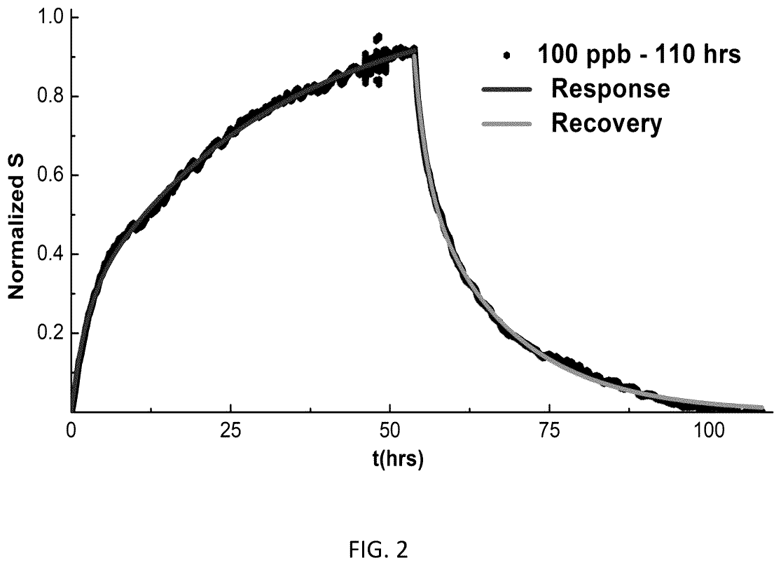

FIG. 2 shows the AFM mapping of a single nanowire with a diameter ˜80 nm (left side) and a bundle of two nanowires (right side). One wire of the bundle is a belt with ˜200 nm width and ˜70 nm thickness. Nanobelts showed some surface roughness.

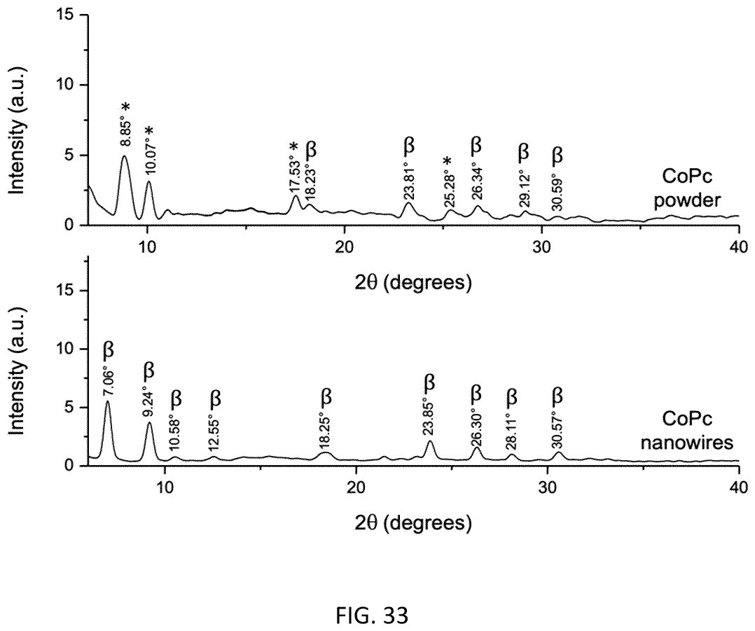

During synthesis of these nanostructures, the most stable phase at high temperatures is formed; in the case of CoPc and FePc this is the β phase (Ballirano et al., 1998; Heutz et al., 2000). FePc nanowires in FIG. 30 show the characteristic XRD peaks at 20=7.05° and 9.25° C. orresponding to the inter-atomic plane separations of β-FePc, d100=12.49 Å and d−102=9.55 Å, respectively. CoPc nanowires shown in FIG. 31 also possessed the characteristic XRD peaks at 20=7.06° and 9.24° C. orresponding to the inter-atomic plane separations of β-CoPc, d100=12.49 Å and d−102=9.55 Å, respectively. In the pattern of CoPc and FePc nanowires grown using our method, the locations of the peaks are somewhat different from the powder precursor which contains mostly the β-MPc phases and some others which could not be identified (FIGS. 32 and 33).

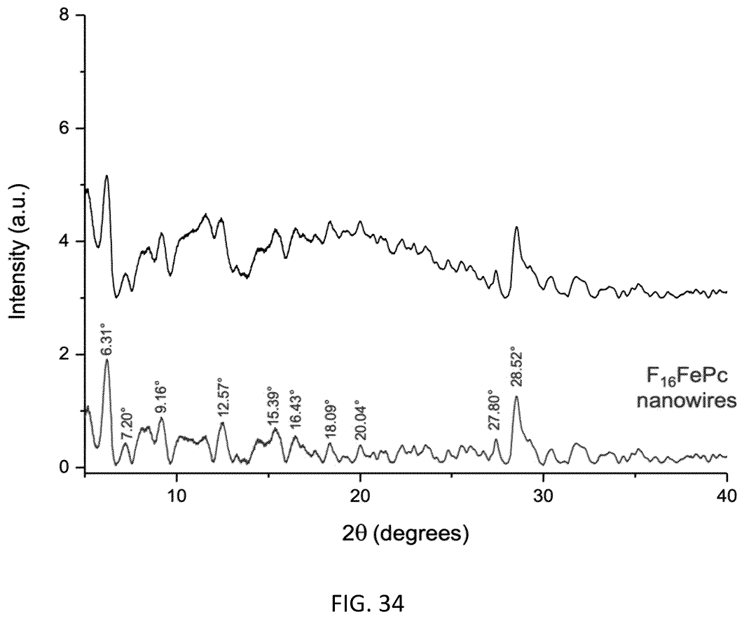

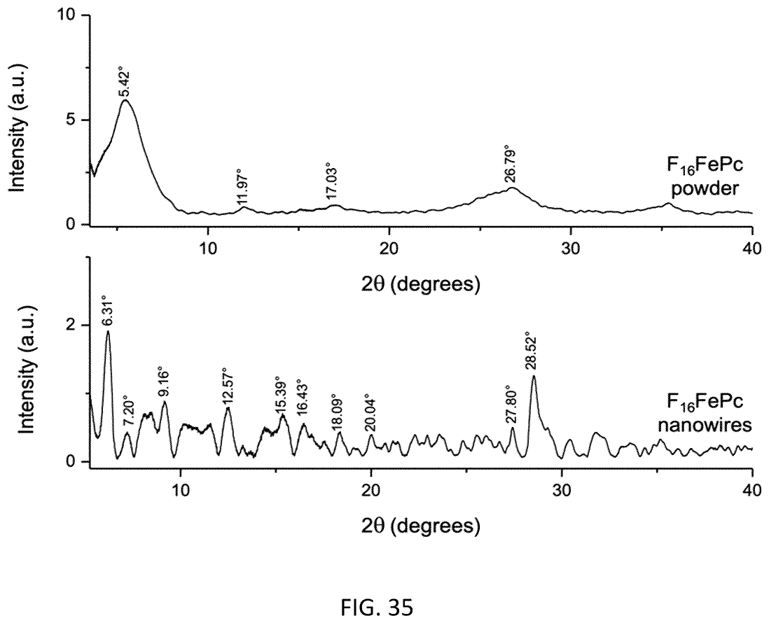

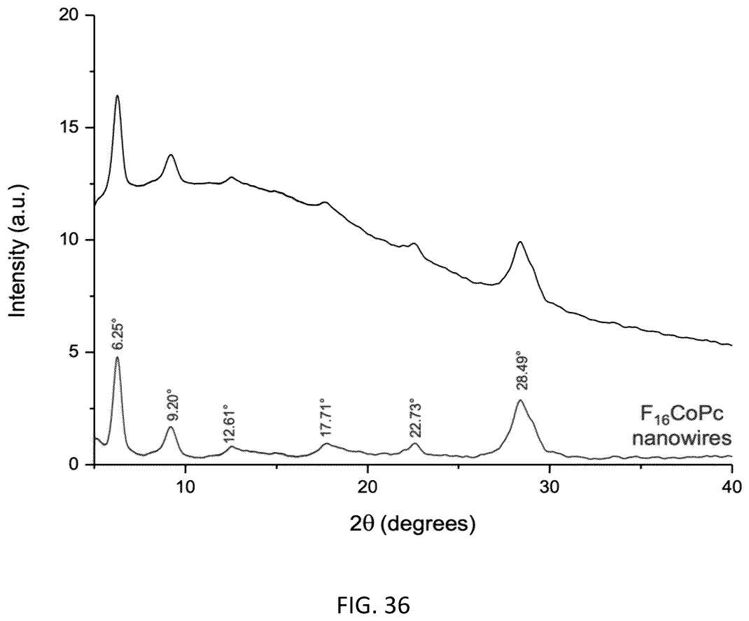

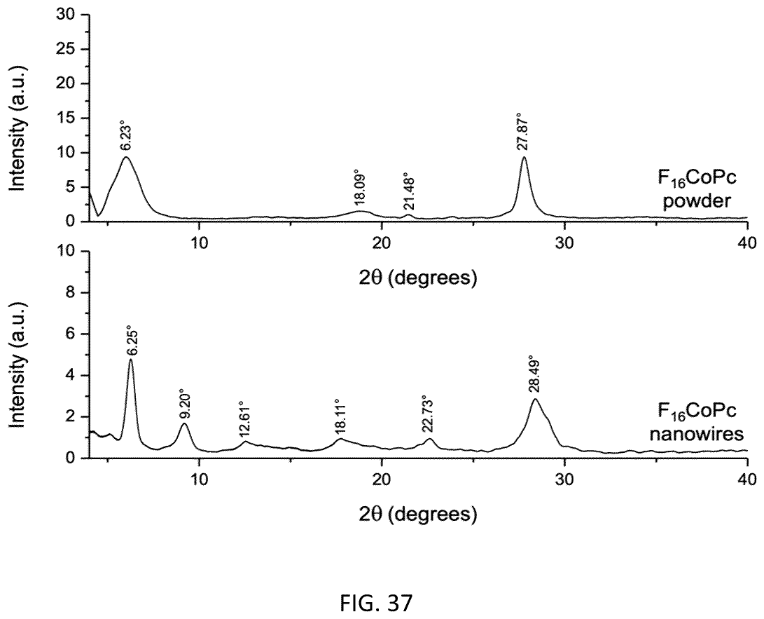

The F₁₆FePc nanowires observed in FIG. 34 and FIG. 35 showed characteristic XRD peaks at 20=6.31° and 28.52° C. orresponding to inter-atomic-plane separations of d001=14.08 Å and d004=3.09 Å; whereas F₁₆CoPc nanowires in FIG. 36 and FIG. 37 showed characteristic XRD peaks at 20=6.25° and 28.49° C. orresponding to the inter-atomic plane separations of d100=14.12 Å and d004=3.13 Å, respectively. Both obtained powder XRD patterns display characteristic Bragg angles of the triclinic crystal system consistent with previous reports in the literature. The locations of the peaks in the powder XRD of our nanowires is also different from the powder precursor, which shows similar diffraction peaks at 20˜6° and 27°, but displaced at lower Bragg angles, indicative of longer interplanar distances.

### Gas Sensing Measurements

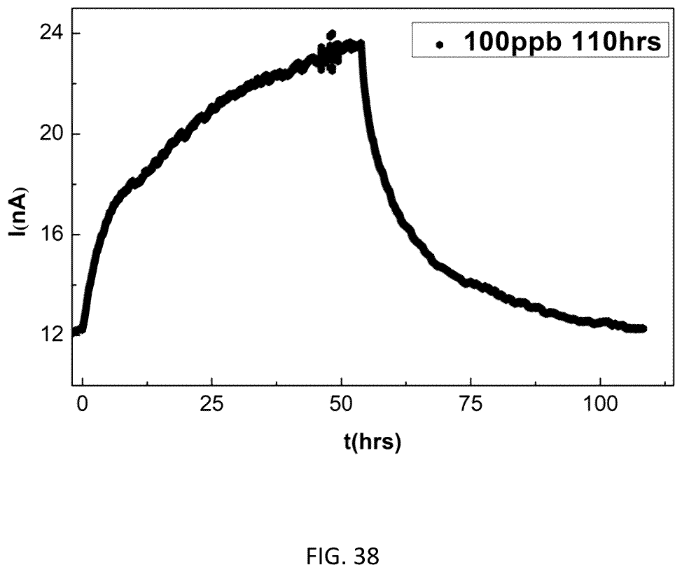

Gas sensing tests showed noticeable increase in the electrical current at constant voltage for as prepared F₁₆FePc nanowires sensors when exposed to NH₃ gas in the ppb range. FIG. 2 gives the time response of S during exposure to 100 ppb ammonia in air. The measurement was prolonged until reasonable stabilization was observed (˜55 hours) followed by a similar recovery time period. The response was consistent with previous reports where no stabilization was reported in experiments involving shorter periods of time as the full cycle involves a considerable amount of time (Gould et al., 2001, Thin Solid Films. 398: 432-437.). The time scale for stabilized response and recovery can be too large for some applications; however, environmental monitoring typically involves time scales in the order of days or more. As a point of reference, the as measured, electrical current versus time is included as FIG. 38. FIG. 2 was derived from this data.

Data in FIG. 2 suggests the contribution of at least two processes, a fast and a slow one, with significantly different time constants. As discussed above, SEM, AFM and TEM characterizations identify F₁₆FePC wires/belts and bundles with a distribution of diameters between 50 nm and 300 nm wherein the larger ones are mostly belts with thickness in the nanoscale (<100 nm). This arrangement offers a significantly large area with direct exposure to the gas where adsorption-controlled kinetics can take place with a relatively short response time. Diffusion inside the wires through surface pores and interfaces (significant in bundles) that has been suggested as the source of a slow response for MPc chemiresistors can be the source of the second process (see, Muckley et al., 2017, Sci. Rep. 7: 1-11.). As observed from previous TEM and AFM characterizations (FIGS. 1, 27 and 28), nanowires are made of a highly crystalline material with reduced density of pores and grain boundaries as compared with thin films (Klyamer et al., 2018), anticipating small diffusion coefficients in a diffusion-controlled kinetics mostly at the bundles interfaces that renders significantly large time constants for this process as compared with the adsorption-controlled initial step at the surface of the wires.

The chemiresistive response of F₁₆MPc has been studied and explained in several reports (see, Klyamer et al., 2018; Alarjah et al., 2009, J. Mater. Sci. 44: 4246-4251; Kaya et al., 2018, J. Porphyrins Phthalocyanines 22: 56-63; Kaya et al., 2019, J. Mater. Sci: Materials in Electronics 30: 7543-7551; Kuprikova et al., 2020, Fluorosubstituted Lead Phthalocyanines: Crystal Structure, Spectral and Sensing Properties. Dyes and Pigments 173: 107939; Schlettwein et al., 1999, J. Phys. Chem. B 103: 3078-3086; Schlettwein et al., 2001, J. Phys. Chem. B 105: 4791-4800). Different to MPc, F₁₆MPc show n-type conductivity due to the electron-withdrawing effect of the fluorine substituents. Surface ionized oxygen reacts with the ammonia gas and the oxygen-localized electrons are released, increasing the density of free electrons in the conduction band, thus reducing the electrical resistance of the nanowire. During testing of the sensors herein prepared the material was maintained in a constant flux of dried synthetic air and the ammonia was added to the flux in the desired proportion.

For the ppb gas concentration range the Langmuir approximation was a reasonable assumption for describing the adsorption kinetics. Following this assumption, the adsorption-controlled process at the surface of the nanowires/nanobelts as the result of the direct interaction of the circulating ammonia flux with the surface-active sites is a fast process where adsorption kinetics instead of diffusion controls the time response. Within the Langmuir approximation, the transient response for the density of immobilized gas molecules at the surface, C, will obey,

$$\frac{\partial c}{\partial t} = {K}_{ads} {c}_{0} ( {C}_{max} - C )$$

where K_{ads} and c₀ are related to the adsorption/desorption rate constants and the ammonia gas concentration in the circulating chamber, respectively (Lu et al., 2000, Sens. Actuators B Chem. 66: 228-231). As a result, the time dependence of the electrical conductance fast response term is modelled as

$$S ( t ) = {A}_{1 F} ( 1 - {e}^{- \frac{t}{{τ}_{1 F}}} )$$

where the fast time constant, τ_{1F} depends on 1/c₀.

The diffusion-controlled slow response is also considered within a linear approximation:

$$\frac{\partial c}{\partial t} = D {∇}^{2} C ,$$

where D is an effective diffusion coefficient (Lu et al., 2000). An expression for the transient response of the electrical conductance in this case involves the integration over the wires volumes, an onerous task for the distribution of shapes shown in FIG. 1A. As an approximation, an overall exponential time decay is used for the conditions assumed (Lu et al., 2000; Gardner et al., 1990, Sens. Actuators B Chem. 1: 166-170). In summary, the 100 ppb F₁₆FePc nanowires sensor response was fitted by the following two-processes equations:

$$S ( t ) = {A}_{1 F} ( 1 - {e}^{- \frac{t}{{τ}_{1 F}}} ) + {A}_{1 S} ( 1 - {e}^{- \frac{t}{{τ}_{1 S}}} ) for the sensor ' s response \qquad ( eql )$$

$$S ( t ) = {A}_{2 F} {e}^{- \frac{t}{{τ}_{2 F}}} + {A}_{2 S} {e}^{- \frac{t}{{τ}_{2 S}}} for the sensor ' s recovery \qquad ( eq2 )$$

where A1F, A1S, τ1F, τ1S and A2F, A2S, τ2F, τ2S, were the fitting parameters for the response (with ammonia) and the recovery (no ammonia) periods with τF, τS as the fast and slow time constants, respectively. The added continuous red and orange lines in FIG. 2 corresponded to the fittings according to eqs (1) and (2). The R² fitting parameter for the model was 0.99756 (response) and 0.99694 (recovery) for the following time constants: τ_{1F}=2.25 hrs, τ₁ₛ=30.41 hrs, τ_{2F}=1.96 hrs, τ_{2S}=14.02 hrs.

The response time constant for the slow process resulted to be larger than the corresponding recovery time constant. This could be assigned to a slow diffusion regime which was consistent with AFM and TEM observations as mentioned above. Within these conditions, a relatively low coverage was expected in the diffusion-controlled slow process for the ammonia gas concentrations studied (<4 ppm) and the linear model was justified.

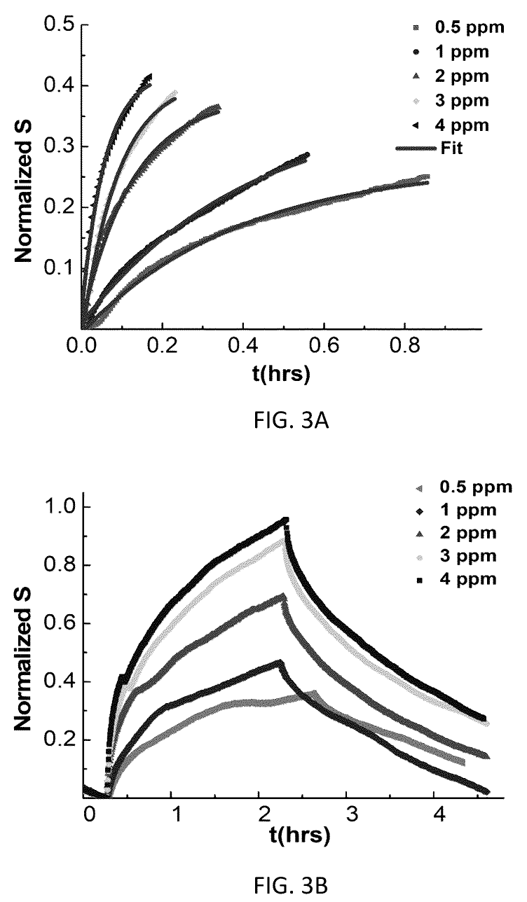

The faster surface process was then analyzed in more detail by measuring the sensors' short time response at different ammonia gas concentrations (100 ppb-4 ppm). FIG. 3A shows S as a function of time for different concentrations, in all cases the ammonia gas exposure time was below 3 hours but large enough to expect stabilization of the fast response. Single exponential decay fittings (fast response) were made for all concentrations and shown as red lines in FIG. 3B. Table 2 summarizes the fast time constants for each tested ammonia concentrations and the R² values of the fittings.

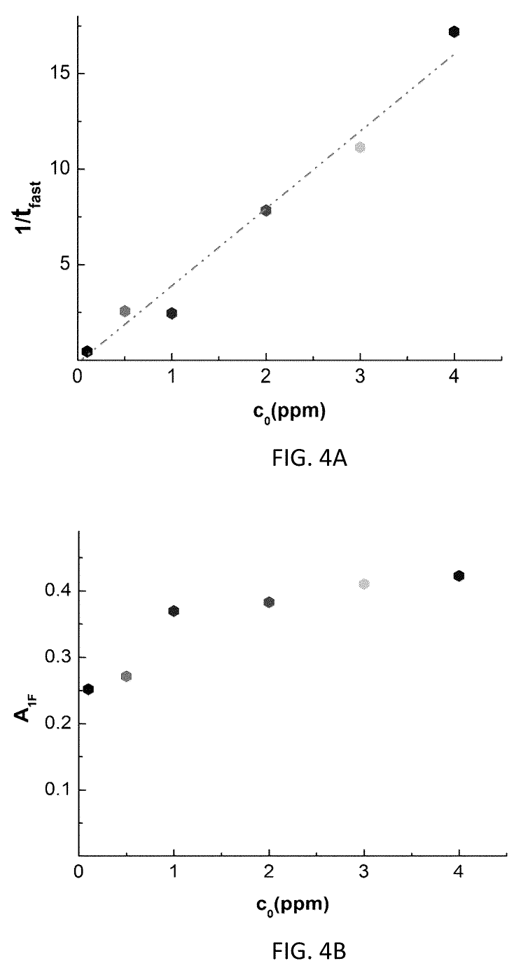

FIG. 4A shows the dependence of 1/τ_{1F} on ammonia gas concentration where an overall linear dependence was observed and was consistent with the adsorption-controlled linear approximation, and FIG. 4B shows the fast response saturation values (A_{1F}) as a function of the NH₃ concentrations.

From the fittings the stabilization values of Sfast (A_{1F}) as a function of the ammonia concentration was obtained and shown in FIG. 4B. Some saturation when reaching 4 ppm was observed. As modeled herein this would imply that the surface sites were reaching maximum coverage value. This possibility was not expected at these relatively low concentrations. At the same time, the assumed linear approximation at such high coverage conditions requires weak interaction between ammonia gas molecules approaching active sites and immobilized species at near sites. The active sites for F₁₆FePC were the central metal sites and according to the molecular structure of this organic semiconductor, the distance between active sites was significantly larger than in typical inorganic metal oxide chemiresistors, thus justifying the use of the linear approximation in this condition. Recently, two pseudo-first order kinetics processes were proposed for the interaction of H₂O vapor with sulfonated CuPc films for H₂O vapor concentrations up to 90% RH (Muckley et al., 2017).

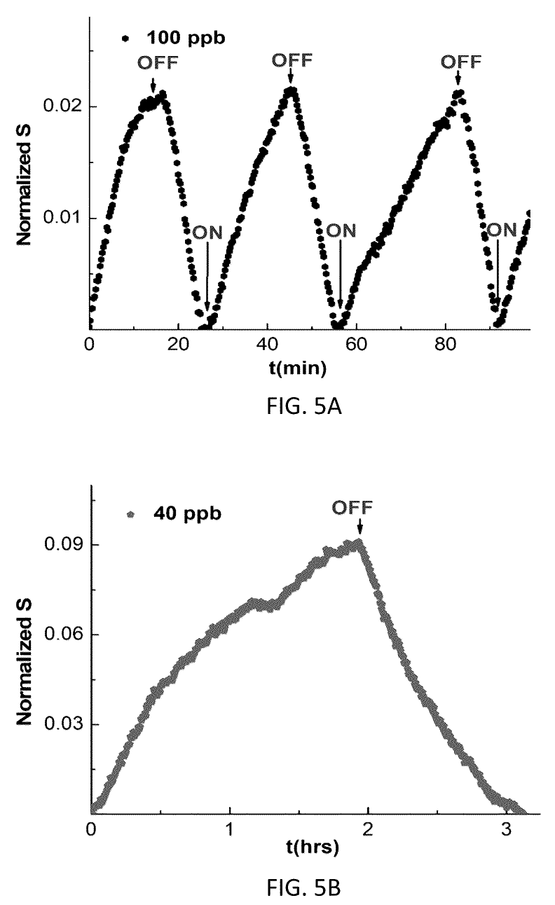

FIG. 5A shows the recovery behavior of the F₁₆FePc nanowires sensor under 100 ppb NH₃ gas exposure. Sensor behavior during three fast cycles demonstrated the reproducibility of the sensor response. The lowest ammonia concentration tested was 40 ppb as shown in FIG. 5B. In order to reach such a low concentration, a mixture of air (500 sccm) and nitrogen (500 sccm) was used as the carrier gas. As observed in the figure, a response in the order of 9% was obtained for ˜2 hrs exposure time. Several sensors were prepared and tested multiple times to evaluate reproducibility with encouraging results.

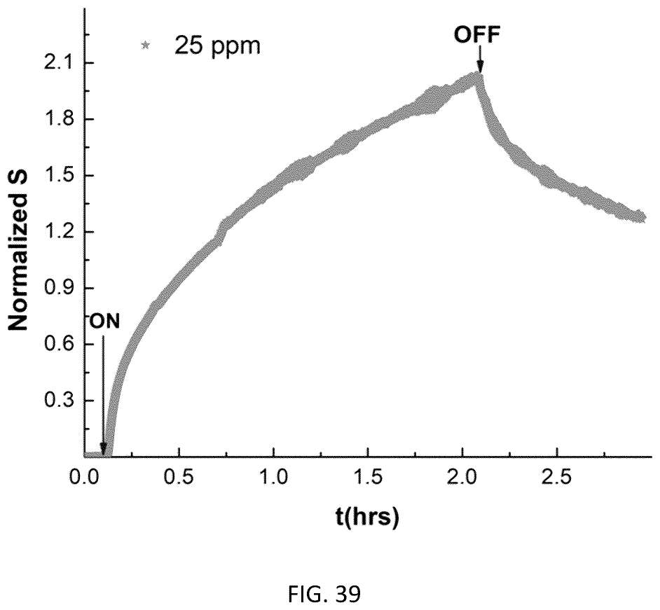

Tests at high NH₃ concentrations showed expected faster response in the order of seconds. For relatively high concentration applications fast response was required according to NIOSH time limits. In FIG. 39 the response of a F₁₆FePc nanowires sensor to 25 ppm NH₃ in air is shown. At these higher levels, the sensor increased its response up to ˜210% in S value in less than 2 hours of detection (NIOSH time limit is 10 hours). Moreover, the fast response reduced its lifetime coefficient significantly and S reached 0.1 (10% current change) in just ˜45 seconds. The time response of the slow component was also inversely proportional to the gas concentration in the linear model (Gardner et al., 1990).

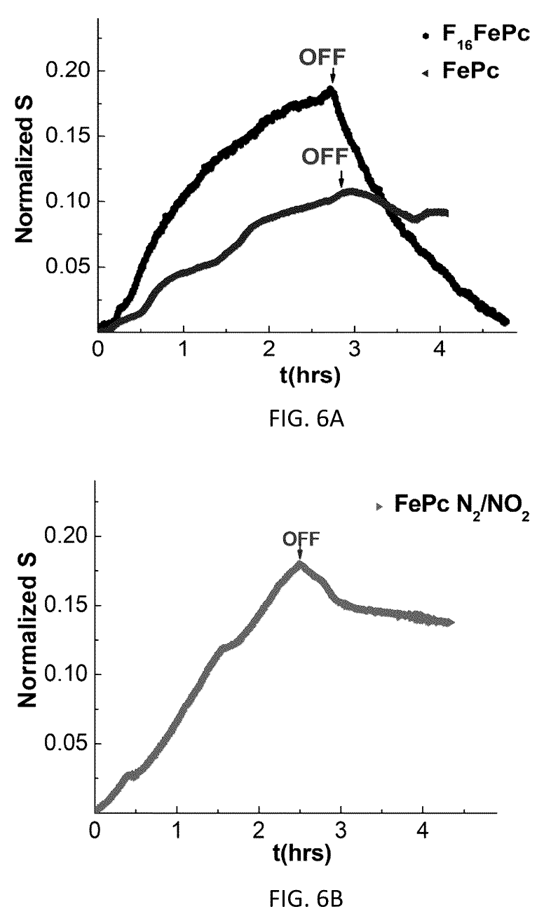

The disclosed device preparation procedure can be used to grow other MPc nanowires. As an example and for comparison, sensors with unsubstituted FePc nanowires were prepared. For FePc precursor, the reactor's ramping rate used was adjusted to 8.25° C./min with a higher sublimation temperature of 450° C. SEM images of the as grown FePc nanowires showed larger widths as compared with substituted samples reaching up to ˜1 μm. The response of the FePc nanowires sensors to NH₃ displayed an increase of the electrical resistance of the FePc chemiresistors compatible with the expected p-type semiconducting behavior of the unsubstituted material but with a very reduced response for analyte gas concentrations in the ppb range. However, their response to oxidizing gases, such as NO₂ was significant with a reduction in the electrical resistance aligned with the p-type semiconducting behavior of the unsubstituted MPc. FIG. 6A shows the FePc sensor response to 100 ppb concentration of NH₃ in air as a function of time. The recovery time of the FePc sensor was very slow as compared with the F₁₆FePc sensors and no total recovery was obtained in FIG. 6A within the testing times. The response of FePc nanowires sensors to 100 ppb NO₂ in nitrogen carrier gas is shown in FIG. 6B. A reduction of the electrical resistance when exposed to the oxidizing gas was observed as expected. This response was significant (18% in ˜2 hrs) and the recovery was relatively slow. However, it is worth mentioning that the use of N₂ as the carrier gas is not representative of the field conditions for the intended application.

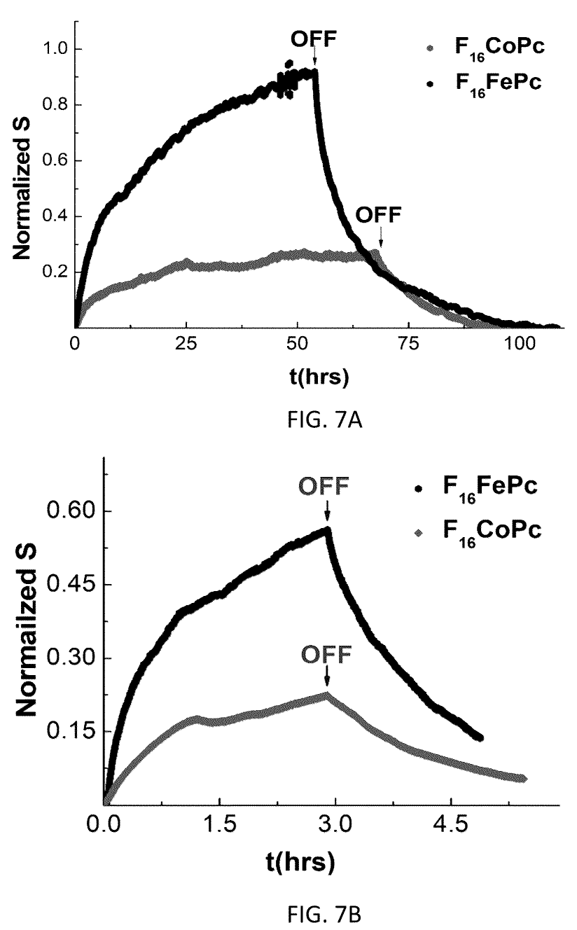

Finally, this nanowire direct growth strategy was tested for F₁₆MPc with other metals. In particular, FIG. 7A shows the response of a F₁₆CoPc nanowires sensor when exposed to 100 ppb NH₃ gas in air. Similar saturation behavior was observed but the sensitivity towards ammonia of the cobalt-based material was significantly reduced when compared with F₁₆FePc. A similar result is observed at higher concentrations. FIG. 7B compares both materials responses to 500 ppb NH₃ concentration in a shorter period of time.

### CONCLUSIONS

Disclosed herein is an efficient, straightforward procedure for fabricating highly sensitive conductance sensors by direct growth of MPc nanowires on interdigitated electrodes by physical vapor transport. Previous to the device fabrication, synthesis of MPc precursors was made by introducing a modified procedure based on the synthesis reported by Rothenberg et al. (2018) in which the reaction was done under solid state conditions without the need of solvents or complex equipment. Interdigitated gold electrodes 5 μm in size were prepared by photolithography on silicon wafers. The as-prepared precursor powders were then sublimated inside a CVD reactor and deposited directly on the IDE devices. By a proper selection of carrying gas flux and IDE substrate temperature, a high yield growth of nanowires directly connected to the electrodes was achieved. This single-step procedure avoided the use of solvents for the deposition of the nanowires on the device resulting in a better electrical contact between the nanowires and the electrodes. Moreover, preferential growth of the thinner nanowires at the gold electrodes was observed, thus increasing the percentage of nanowires in direct electrical contact between adjacent electrodes. The procedure was successful for substituted and unsubstituted metal phthalocyanine nanowires including different metals (Fe²⁺ and Co²⁺).

Using this approach, conductometric sensors from substituted and unsubstituted MPc nanowires were fabricated and tested for ppb gas sensing. Among the materials tested, sensor prepared with F₁₆FePc nanowires showed high sensitivity, reproducibility, recovery, and stability. For the detection of NH₃, two processes with significantly different time constants were identified in the response of the sensor. For 100 ppb NH₃ concentration in air at room temperature, the fast component (τ_{fast} ˜2.25 hrs) was assigned to the interaction of the analyte with the adsorbed oxygen at the surface of the nanowires. The slow component (τ_{slow}˜30.41 hrs) was assigned to the diffusion of the ammonia through bundles' interfaces and reduced surface porosity of the nanowires. The fabrication method was tested for other MPc nanowires. Results for unsubstituted FePc and F₁₆CoPc nanowires were presented and compared. Among all the materials studied, F₁₆FePc nanowires showed improved stability and recovery. For applications where a “fast” response is required, the investigated F₁₆FePc nanowires devices offer ˜2% normalized signal change for a response time of ˜12 min in the case of 100 ppb, ˜20 minutes in the case of 40 ppb, and a few seconds in the case of 25 ppm.

F₁₆FePc nanowires devices are thus ideal for applications related to the monitoring of “recovery zones” where the testing periods are longer and in the range of days and months. The interest on these zones is on the evaluation of the expected decrease of relative high concentration levels of contaminant gases (such as NH₃) but still in the low ppb range. For such long-term applications, the response of these sensors can take advantage of the slow response that expands the detection limit below 20 ppb (the presented data show detection values above 20% for 100 ppb and 10% for 40 ppb for ˜3 hours detection periods). The fact that these sensors based on MPc nanowires operate at room temperature and consume minimal power (as an example, in FIG. 2 at t=2.7 hrs, the electrical current intensity is ˜7 nA with 5 V applied voltage for a consuming power of 35 nW) makes them appropriate for very low energy consumption, free-standing, long term operations. Scalability and production methods are not within the scope of this article and should be considered in future works.

While particular aspects and embodiments are disclosed herein, other aspects and embodiments will be apparent to those skilled in the art in view of the foregoing teaching. The various aspects and embodiments disclosed herein are for illustration purposes only and are not intended to be limiting, with the true scope and spirit being indicated by the following claims.

We claim:

1. A method for monitoring a gaseous mixture for an analyte, the method comprising:
providing a sensor comprising nanowires, wherein the nanowires comprise a metal phthalocyanine complex of formula (I): 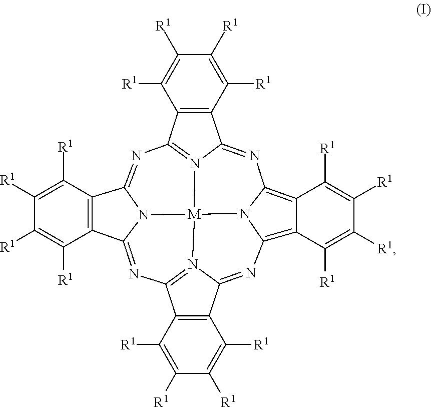
wherein M is iron or cobalt, and wherein each R¹ is independently H or F;
contacting the sensor with the gaseous mixture; and
monitoring the electrical properties of the sensor, wherein the presence of the analyte alters the electrical properties of the sensor.

2. The method of claim 1, wherein M is Fe²⁺.

3. The method of claim 1, wherein M is Co²⁺.

4. The method of claim 1, wherein R¹ is H.

5. The method of claim 1, wherein R¹ is F.

6. The method of claim 1, wherein the nanowires are crystalline.

7. The method of claim 6, wherein the nanowires comprise a crystal polymorph characterized in that it provides an X-ray diffraction pattern comprising at least the peaks selected from one of the following sets (2θ±0.1 degrees):
(i) 7.1, 9.3;
(ii) 7.1, 9.2; or
(iii) 6.3, 28.5.

8. The method of claim 1, wherein the nanowires comprise at least 90 wt % metal phthalocyanine.

9. The method of claim 1, wherein the nanowires are a p-type semiconductor or n-type semiconductor.

10. The method of claim 1, wherein the nanowires are an n-type semiconductor.

11. The method of claim 1, wherein the sensor further comprises a gapped electrode, wherein the nanowires are deposited so as to complete an electrical circuit across the gapped electrode.

12. The method of claim 11, wherein the gapped electrode is an interdigitated electrode.

13. The method of claim 1, wherein the gaseous mixture comprises the analyte.

14. The method of claim 13, wherein the analyte comprises CO, NH₃, and/or NOₓ, wherein x is 1 or 2.

15. The method of claim 13, wherein the analyte comprises NH₃ or NO.

16. The method of claim 13, wherein the analyte is present in an amount in the range of 40 ppb to 100 ppm.

17. The method of claim 16, wherein the analyte is present in an amount in the range of 40 ppb to 1 ppm.

18. The method of claim 1, wherein the gaseous mixture comprises N₂.

19. The method of claim 1, wherein the gaseous mixture comprises at least 90 wt % air.

20. The method of claim 1, wherein the monitoring the electrical properties comprises completing a circuit with the sensor, and monitoring at least one of the current, voltage, or resistance across the sensor.

21. The method of claim 1, wherein the gaseous mixture comprises an analyte, wherein the method comprises:
determining a baseline current, voltage, or resistance across the sensor in the presence of a control gaseous mixture that does not comprise the analyte, and then determining a detection current, voltage, or resistance across the sensor in the presence of the gaseous mixture.

22. A method for making a sensor, the sensor comprising nanowires on an gapped electrode, the method comprising:
providing a gapped electrode and a metal phthalocyanine complex of formula (I): 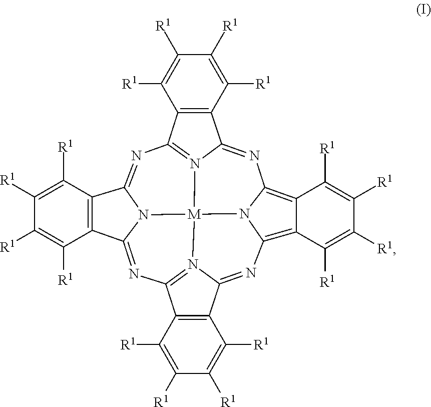
wherein M is iron or cobalt, and each R¹ is independently H or F; and
reducing the pressure to no more than 1 Torr and raising the temperature to at least 100° C. for a time of at least 20 minutes,
wherein the metal phthalocyanine complex is deposited as nanowires on the gapped electrode.

23. A sensor, the sensor comprising nanowires deposited on a gapped electrode, wherein the nanowires are comprised of a metal phthalocyanine complex of formula (I): 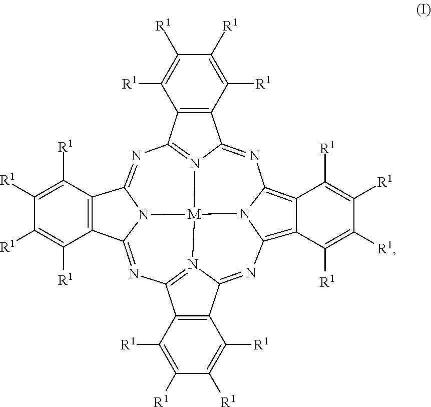
wherein M is iron or cobalt, and each R¹ is independently H or F.

24. A system for monitoring a gaseous mixture for an analyte, the system comprising:
a sensor comprising nanowires deposited on a gapped electrode, wherein the nanowires comprise a metal phthalocyanine complex, wherein the nanowires are deposited so as to complete an electrical circuit;
a meter connected to the electrical circuit and configured to measure the electrical properties of the sensor; and
an input stream configured to contact the gaseous mixture with the sensor, wherein the presence of the analyte alters the electrical properties of the sensor.
